(19) United States
(12) Patent Application Publication
(10) Pub. No.: US 2024/0372260 A1
(43) Pub. Date: Nov. 7, 2024

(54) ELECTRONIC DEVICE INCLUDING ANTENNA

(71) Applicant: SAMSUNG ELECTRONICS CO., LTD., Suwon-si (KR)

(72) Inventors: Munjin JEONG, Suwon-si (KR); Yitae KANG, Suwon-si (KR); Jaeyoung YANG, Suwon-si (KR); Yoonjung KIM, Suwon-si (KR); Hyunwoo Lee, Suwon-si (KR)

(21) Appl. No.: 18/777,785

(22) Filed: Jul. 19, 2024

Related U.S. Application Data
(63) Continuation of application No. PCT/KR2023/001030, filed on Jan. 20, 2023.

(30) Foreign Application Priority Data
Jan. 21, 2022 (KR) 10-2022-0009412
Mar. 24, 2022 (KR) 10-2022-0036758

(51) Int. Cl. H01Q 9/04; H01Q 1/24; H01Q 1/38; H01Q 21/28

(52) U.S. Cl. CPC H01Q 9/0414; H01Q 1/241; H01Q 1/38; H01Q 21/28

(57) ABSTRACT

An electronic device includes a housing including a conductive portion, a printed circuit board inside the housing, and a conductive antenna member which is inside the housing and electrically connects the printed circuit board to the housing. The conductive antenna member includes a contact at which the conductive antenna member is secured to and electrically connected to the conductive portion of the housing, and the contact including a curved portion.

### CROSS-REFERENCE TO RELATED APPLICATIONS

This application is a continuation application of International Application No. PCT/KR2023/001030 designating the United States, filed on Jan. 20, 2023, at the Korean Intellectual Property Receiving Office and claiming priority to Korean Patent Application No. 10-2022-0009412, filed on Jan. 21, 2022, and Korean Patent Application No. 10-2022-0036758 filed on Mar. 24, 2022, at the Korean Intellectual Property Office, the disclosures of which are incorporated by reference herein in their entireties.

### BACKGROUND

### (1) Field

Various embodiments disclosed in this document relate to an electronic device including an antenna.

### (2) Description of the Related Art

An electronic device includes antenna modules supporting wireless communication services of various frequency bands, for example, 3rd generation (3G), 4th generation (4G), or 5th generation (5G) services. Meanwhile, a processor (e.g., a communication processor (CP)) of the electronic device communicates with a base station, and determines a communication scheme to be used in the electronic device. For example, wireless communication circuitry of the electronic device may communicate with the base station using one or more of a 3G/4G communication scheme, or a 5G communication scheme.

Also, to secure the antenna modules including the communication circuitry and the antenna inside the electronic device, the antenna modules may be fixed inside the electronic device by utilizing a fastening member including a screw.

### SUMMARY

Within an electronic device, a conductive portion of a housing used as an antenna radiator may be electrically connected to a wireless communication circuit by various connection structures. For example, the various connection structures may include a c-clip connection structure or a direct connection structure using a conductive member.

However, in the c-clip connection structure, the c-clip may be separated or deformed within an electronic device due to an external impact applied to the external device, such as be dropping the electronic device. As a result, antenna performance may be degraded.

In addition, in the direct connection structure using the conductive member, the conductive member may be electrically connected directly with the conductive portion of the housing by a fastening member such as a screw. However, if the fastening member is improperly fastened, the conductive portion of the housing and the conductive member may not contact in part such as to be disconnected. As the conductive portion of the housing and the conductive member of the electronic device do not contact, the antenna performance may be deteriorated.

Various embodiments disclosed in this document may provide an electronic device having improved antenna performance even with incorrect or damaged fastening of antenna elements.

According to various embodiments disclosed in this document, an electronic device may include a housing formed at least in part of a conductive portion, a printed circuit board (PCB) disposed inside the electronic device, a conductive member including a contact area and contacting a conductive portion of the housing through at least a part of the contact area, the contact area including at least one first contact portion which contacts the fastening member, and at least one second contact portion which extends to be curved from the first contact portion and contacts the conductive portion, and a conductive connect member for electrically interconnecting the PCB and the conductive member, the conductive member may be secured to the conductive portion of the housing, and if the conductive member is secured to the conductive portion of the housing, the contact between the second contact portion extending to be curved and the conductive portion may be maintained, and thus the conductive member and the conductive portion of the housing may be electrically connected.

According to various embodiments disclosed in this document, an electronic device may include a housing formed at least in part of a conductive portion, a PCB disposed inside the electronic device, an antenna assembly electrically connected with the wireless communication circuit and the conductive portion of the housing, a fastening member for securing a part of the antenna assembly to the conductive portion of the housing, a conductive member including a contact area and contacting a conductive portion of the housing through at least a part of the contact area, the contact area including at least one first contact portion, at least one second contact portion contacting the conductive portion, and a first hole having a curved rim formed by the first contact portion and the second contact portion, and a conductive connect member for electrically interconnecting the PCB and the conductive member, the fastening member may be disposed in the first hole and a second hole formed in the conductive portion, to thus secure the conductive member to the conductive portion of the housing, and if the conductive member is secured to the conductive portion of the housing by the fastening member, the contact between the second contact portion extending to be curved and the conductive portion may be maintained, and thus the conductive member and the conductive portion of the housing may be electrically connected.

According to various embodiments disclosed in this document, an electronic device may provide a conductive structure by which antenna performance is not degraded even with incorrect fastening of such structure.

Also, according to various embodiments, the electronic device may provide an antenna structure having improved connection structure even during a fastening process using a fastening member.

Besides, various effects obtained directly or indirectly through this document may be provided.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a front perspective view of an electronic device, according to an embodiment.

FIG. 2 is a rear perspective view of an electronic device, according to an embodiment.

FIG. 3 is an exploded view of an electronic device, according to an embodiment.

FIG. 4 is an enlarged plan view of an inside of an electronic device, according to an embodiment.

FIG. 5 is a perspective view of an antenna assembly, according to an embodiment.

FIG. 6A is an enlarged cross-sectional view of a conductive member, FIG. 6B is an enlarged view of region 6-1 in FIG. 6A and FIG. 6C is an enlarged perspective view of region 6-2 in FIG. 6B, according to an embodiment.

FIG. 7A is an enlarged cross-section view of a conductive member, and FIG. 7B is an enlarged perspective view of region 7-1 in FIG. 7A, according to an embodiment.

FIG. 8A is an enlarged cross-sectional view of a conductive member, FIG. 8B is an enlarged view of region 8-1 in FIG. 8A, and FIG. 8C is an enlarge perspective view of region 8-1 in FIG. 8A, according to an embodiment.

FIG. 9A is an enlarged cross-sectional view of a conductive member, FIG. 9B is an enlarged view of region 9-1 in FIG. 9A, and FIG. 9C is an enlarged perspective view of region 9-1 in FIG. 9A, according to an embodiment.

FIG. 10A is an enlarged cross-sectional view of a conductive member, FIG. 10B is an enlarged perspective view of region 10-1 in FIG. 10A, and FIG. 10C is a cross-sectional view of region 10-2 in FIG. 10B, according to an embodiment.

FIG. 11A is an enlarged cross-sectional view of a conductive member, FIG. 11B is an enlarged perspective view of region 11-1 in FIG. 11A, FIGS. 11C and 11D are enlarged plan views of region 11-1 in FIG. 11A, according to an embodiment.

FIG. 12 is a diagram illustrating an electronic device in a network environment according to an embodiment.

With respect to description of the drawings, like or similar reference numerals may be used for like or similar elements.

### DETAILED DESCRIPTION

Hereinafter, various embodiments of the present invention shall be described with reference to the accompanying drawings. However, it should be understood that this is not intended to limit the present invention to a specific embodiment, and embraces various modifications, equivalents, and/or alternatives of the embodiments of the present invention.

An electronic device 100 according to an embodiment of the present invention is described with a bar-type electronic device as an example, but the following embodiment may be applied to electronic devices such as slidable, rollable, and foldable types, which is not limited thereto.

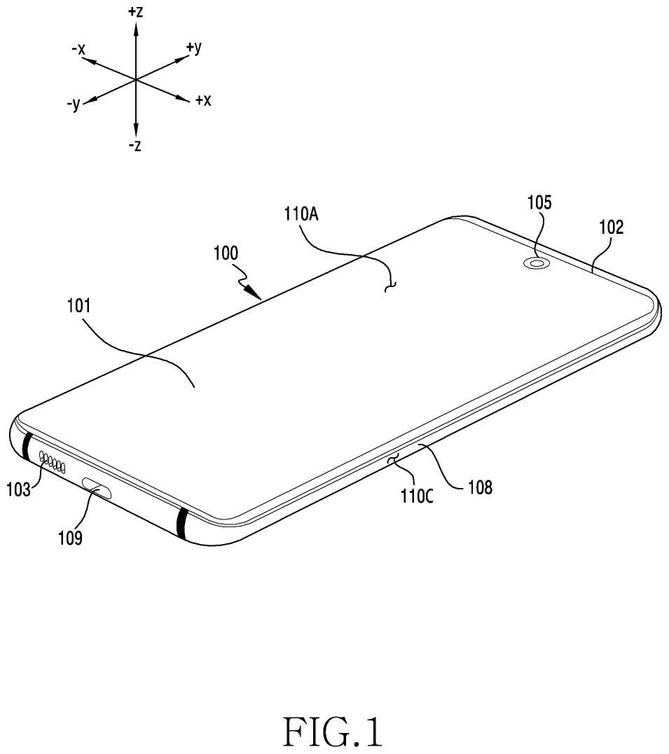

FIG. 1 is a front perspective view of an electronic device, according to an embodiment.

Referring to FIG. 1, the electronic device 100 according to an embodiment may include a housing 110 which includes a first surface (or a “front surface”) 110A, a second surface (or a “rear surface”) 110B, and a side surface (or a “side wall”) 110C surrounding a space between the first surface 110A and the second surface 110B. In an embodiment (not shown), the housing 110 may indicate a structure which forms a part of the first surface 110A, the second surface 110B, and the side surface 110C of FIG. 1.

The electronic device 100 may be disposed in a plane defined by a second direction (or an x direction) and a third direction (or a y direction) which cross each other. A thickness of the electronic device 100 and various components or layers thereof may be defined along a first direction (or a z direction) which intersects each of the first and second directions (e.g., a thickness direction). As crossing or intersecting, the various directions may be perpendicular to each other without being limited thereto.

Referring to FIG. 1 according to an embodiment, the first surface 110A may be formed (or defined) by a front plate 102 (e.g., a glass plate including various coating layers, or a polymer plate) which is at least in part substantially transparent to light. According to an embodiment, at least one side edge portion of the front plate 102 may include a curved portion which bends from the first surface 110A and extends seamlessly toward a rear plate 111.

According to an embodiment, the side surface 110C may be coupled with the front plate 102 and the rear plate 111 (e.g., couple the front plate 102 and the rear plate 111 to each other), and may be formed (or provided (by a side member 108 including metal and/or polymer. In an embodiment, the rear plate 111 and the side member 108 may be integrally formed and include the same material (e.g., a metal material such as aluminum). As being integrally formed, members may be provided as a single, unitary, continuous element.

According to an embodiment, the electronic device 100 may include at least one of a display 101, an audio module 103, a sensor module (not shown), camera modules 105, 115, 112, 113 and 106, a key input device 117 and a connector hole 109. In an embodiment, the electronic device 100 may omit at least one (e.g., the key input device 117) of the components or may additionally include other component.

In an example, the electronic device 100 may include a sensor module which is not shown. For example, the sensor module may be disposed on a rear surface of a screen display area of the display 101 which is visible to or exposed to outside of the electronic device 100 through the front plate 102.

For example, at least one of an optical sensor, an ultrasonic sensor or a capacitive sensor may be disposed on the rear surface of the screen display area of the display 101, which is not limited thereto.

In an embodiment, the electronic device 100 may further include a light emitting element, and the light emitting element may be disposed at a position adjacent to the display 101 within an area (e.g., a planar area) provided by the front plate 102. The light emitting element may provide, for example, state information or status information of the electronic device 100, in the form of or relating to light. In an embodiment, the light emitting element may provide, for example, a light source interworking with the operation of the camera module 105. The light emitting element may include, for example, a light emitting diode (LED), an infrared (IR) LED and/or a xenon lamp.

According to an embodiment, the display 101 may be visible to the outside of the electronic device 100 through a significant portion of the planar area of the front plate 102. In an embodiment, an outer edge of the display 101 may be formed to be mostly identical to an adjacent outer shape (e.g., a curved surface) of the front plate 102.

According to an embodiment (not shown), the electronic device 100 may form or have defined therein a recess, a notch, or an opening in a part of the screen display area of the display 101. Various electronic components, for example, the camera module 105 or the sensor module which is not shown may be disposed in the recess, the notch, or the opening.

According to an embodiment, the audio module 103 may include a microphone hole and/or a speaker hole. A microphone for acquiring external sound may be disposed inside the microphone hole, and a plurality of microphones may be disposed to detect a sound direction in an embodiment. According to an embodiment, the speaker hole and the microphone hole may be implemented as a single hole, or a speaker may be included without the speaker hole (e.g., a piezo speaker). The speaker hole may include, for example, an external speaker hole and a call receiver hole.

The electronic device 100, which includes the sensor module which is not shown, may generate an electrical signal or a data value corresponding to its internal operating state or an external environmental state of the electronic device 100. The sensor module may include a proximity sensor disposed on or exposed at the first surface 110A of the housing 110, a fingerprint sensor disposed on or exposed at the rear surface of the display 101, and/or a biometric sensor (e.g., a heart rate monitor (HRM) sensor) disposed on or exposed at the second surface 110B of the housing 110.

The sensor module may further include at least one of, for example, a gesture sensor, a gyro sensor, an air pressure sensor, a magnetic sensor, an acceleration sensor, a grip sensor, a color sensor, an IR sensor, a biosensor, a temperature sensor, a humidity sensor, and an illuminance sensor. The aforementioned modules (e.g., sensor module, camera module, etc.) may be otherwise referred to as an electronic component or functional component which provides a function to the electronic device 100, such as be using light, sound, pressure, proximity, etc. of one or more objects external to the electronic device 100.

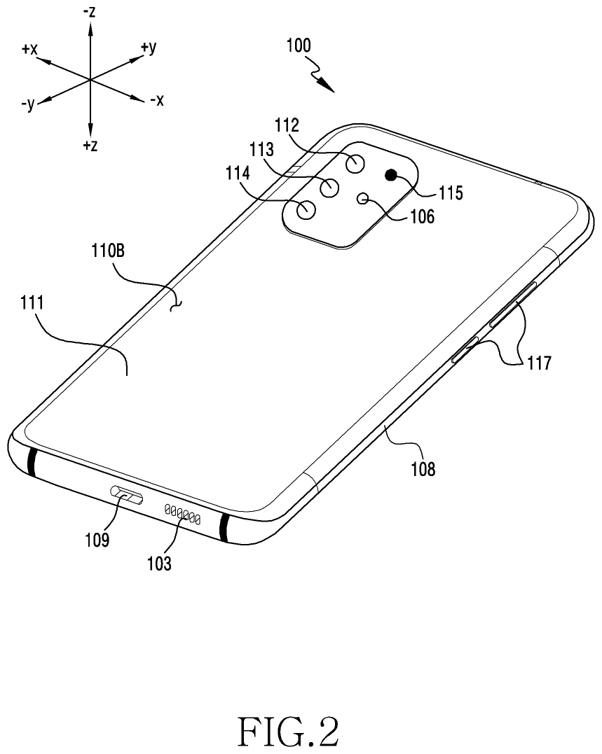

FIG. 2 is a rear perspective view of an electronic device, according to an embodiment.

Referring to FIG. 2 according to an embodiment, the second surface 110B may be formed by the rear plate 111 which is substantially opaque. The rear plate 111 may be formed of, for example, coated or tinted glass, ceramic, polymer, metal (e.g., aluminum, stainless steel (STS), or magnesium), or a combination of at least two of these materials. According to an embodiment, at least one side edge portion (e.g., an outer edge) of the rear plate 111 may include a curved portion which bends from the second surface 110B and extends seamlessly toward the front plate 102.

According to an embodiment, at least one of the camera module (e.g., 112, 113, 114, 115), the fingerprint sensor, and a flash (e.g., 106) may be disposed on the second surface 110B. According to an embodiment (not shown), the display 101 may be combined with or disposed adjacent to a touch sensing circuit, a pressure sensor for measuring an intensity (pressure or proximity) of a touch, and/or a digitizer for detecting a magnetic stylus pen as an input device.

According to an embodiment, the camera modules 105, 112, 113, 114, 115, and 106 may include the first camera module 105 disposed on the first surface 110A of the electronic device 100, and the second camera modules 112, 113, 114, and 115 disposed on the second surface 110B, and/or the flash 106. For example, the above camera modules 105, 112, 113, 114, and 115 may include one or more lenses, an image sensor, and/or an image signal processor. The flash 106 may include, for example, a light emitting diode or a xenon lamp. In an embodiment, two or more lenses (an infrared camera, wide-angle and telephoto lenses) and image sensors may be disposed on one surface of the electronic device 100.

According to an embodiment, the key input device 117 may be disposed on the side surface 110C of the housing 110. In an embodiment, the electronic device 100 may not include a part or whole of the aforementioned key input device 117 as a hard key, and the key input device 117 not included may be implemented in a different form such as a soft key on the display 101. In an embodiment, the key input device may include at least a part of the fingerprint sensor disposed on the second surface 110B of the housing 110.

According to an embodiment, the connector hole 109 may accommodate a connector (not shown) for transmitting and receiving power and/or data to and from an external electronic device, and/or a connector for transmitting and receiving an audio signal to and from an external electronic device. For example, the connector hole 109 may include a universal serial bus (USB) connector or an earphone jack. In an embodiment, the USB connector and the earphone jack may be implemented as a single hole (e.g., 109 of FIG. 1 and FIG. 2), and according to an embodiment (not shown), the electronic device 100 may transmit and receive power and/or data, or transmit and receive an audio signal to and from the external electronic device without a separate connector hole.

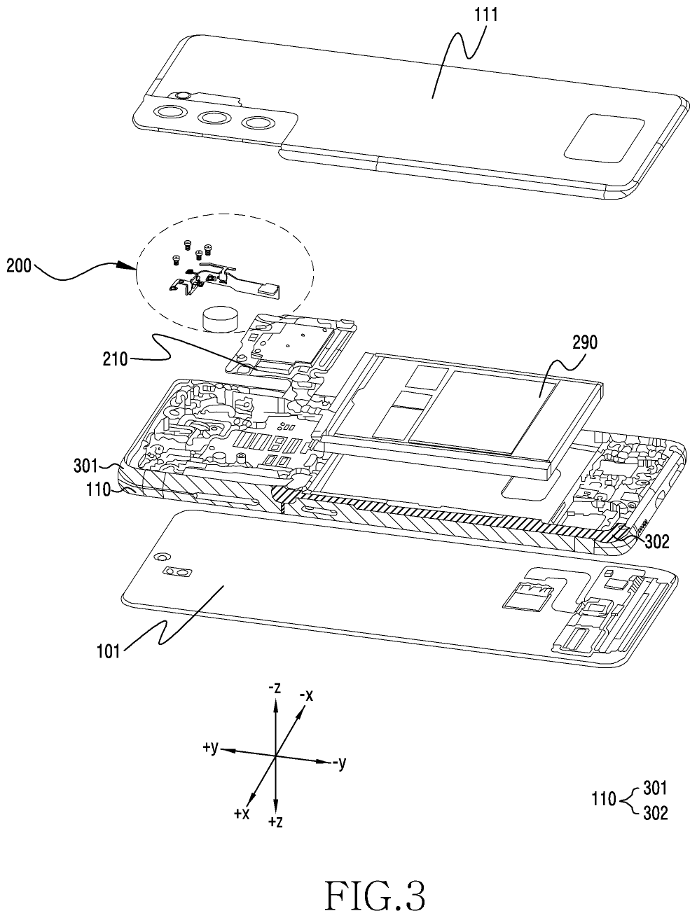

FIG. 3 is an exploded view of an electronic device, according to an embodiment.

According to an embodiment, FIG. 3 illustrates an embodiment of an inside of the electronic device.

According to an embodiment, the electronic device 100 may include the housing 110, the display 101, the rear plate 111, an antenna assembly 200, a printed circuit board (PCB) 210, and a battery 290.

According to an embodiment, the display 101 may be disposed on and/or define the front surface (110A of FIG. 1) of the electronic device 100.

According to an embodiment, a front surface of the display 101 (e.g., one surface as a major in the +z direction of FIG. 3) may be disposed on or define the front surface of the electronic device 100 and be visually exposed to the outside (e.g., outside of the electronic device 100).

According to an embodiment, a rear surface (e.g., one surface as a major in the −z direction of FIG. 3) opposite to the front surface of the display 101 may be disposed the inside of the electronic device 100 not to be visually exposed to the outside. For example, the rear surface of the display 101 may be disposed toward a plurality of components (e.g., a battery) disposed inside the electronic device 100.

According to an embodiment, the housing 110 may protect the internal components of the electronic device 100 from external impact or foreign substance entry.

According to an embodiment, the housing 110 may form a part of the front surface 110A and the side surface 110C of the electronic device 100. In one example, the housing 110 may reduce damaging of the PCB 210 disposed inside the electronic device 100 and/or a plurality of electronic components (e.g., the battery 290) disposed on the PCB 210, by the external impact.

According to an embodiment, an intermediate part of the housing 110 may be used as an antenna radiator. According to an embodiment, the intermediate part of the housing 110 may be formed of (or include) a conductive portion 301 and a nonconductive portion 302. For example, a part of an outer edge of the intermediate part of the housing 110 may be formed of a metal member, such as to be conductive. For example, another part of the edge of the intermediate part of the housing 110 may be formed of an injection member, such as to be nonconductive. According to an embodiment, the intermediate part of the housing 110 formed of (or by) the conductive portion 301 may be electrically connected to the PCB 210 and used as the antenna radiator. That is, an intermediate housing (e.g., labelled 110 in FIG. 3 as including the conductive portion 301 and the nonconductive portion 302) may be electrically connected to the PCB 210 at the conductive portion 301, that is, at the antenna radiator. Here, the housing 110 (e.g., one or more of 102, 111, the intermediate housing, etc.) may be electrically connected to the PCB 210, at the antenna radiator.

According to an embodiment, the antenna assembly 200, the PCB 210, and the battery 290 may be disposed in an internal space of the electronic device 100 formed by the intermediate part of the housing 110, the display 101, and the rear plate 111 together with each other.

According to an embodiment, the antenna assembly 200 may be disposed in an inner area of the electronic device 100 which is adjacent to the PCB 210. In one example, the antenna assembly 200 may be disposed in an area opposite to the battery 290 based on the area where the PCB 210 is disposed. In one example, the antenna assembly 200 may be disposed in an inner area of the electronic device 100 between the PCB 210 and the edge of the side surface 110C of the housing 110, such as an inner surface of the side surface 110C defining the edge. For example, the antenna assembly 200 may be disposed in the inner area of the electronic device 100 adjacent to (or closest to) a part of the edge of the side surface 110C of the housing 110 formed of the conductive portion 301.

According to an embodiment, a plurality of electronic components may be disposed on at least one PCB 210, such that the PCB 210 may be considered as including such electronic components. In one example, a wireless communication circuit (not shown), a processor (not shown), a memory (not shown), and/or an interface (not shown) may be disposed on at least one PCB 210.

According to an embodiment, the battery 290 may be disposed between the intermediate part of the housing 110 and the rear plate 111. According to an embodiment, the battery 290 may be accommodated in a space formed inside the housing 110 and electrically connected with the PCB 210. For example, a specific space may be formed inside the housing 110 by a metal member or an injection member, and the battery 290 may be accommodated in the specific space.

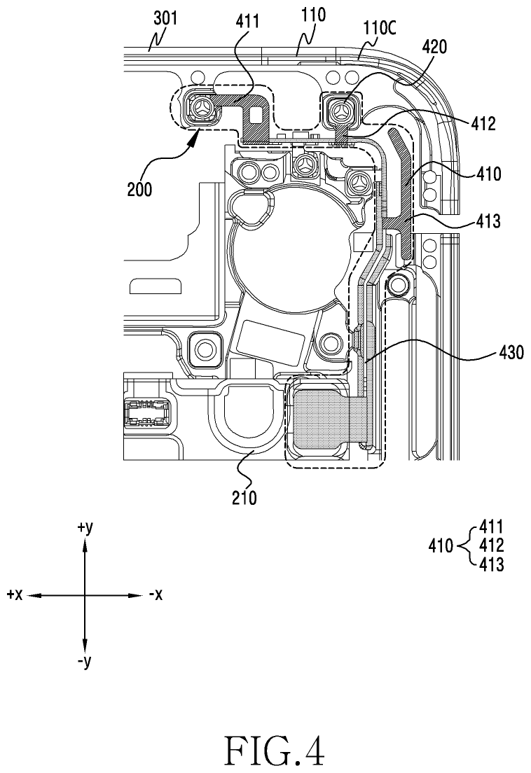

FIG. 4 is an enlarged plan view of an inside of an electronic device, according to an embodiment. FIG. 4 may be view at a corner of the electronic device in FIG. 3.

According to an embodiment, FIG. 4 illustrates the antenna assembly 200 and the PCB 210 disposed inside the electronic device 100.

According to an embodiment, the antenna assembly 200 may be disposed inside the electronic device 100 and connected with the PCB 210 and the housing 110. In one example, the antenna assembly 200 may be disposed inside the electronic device 100 and electrically connected to the PCB 210 and the housing 110. For example, one end of the antenna assembly 200 may be electrically connected to the PCB 210, and the other end of the antenna assembly 200 may be electrically connected to the conductive portion 301 of the housing 110. Here, the antenna assembly 200 may be electrically connected to the PCB 210 at a first end of the antenna assembly 200 and electrically connected to the intermediate housing (or antenna radiator) at a second end of the antenna assembly 200 which is opposite to the first end along a length of the antenna assembly 200.

According to an embodiment, the antenna assembly 200 may include a conductive antenna member such as one or more of a conductive member 410, a conductive connect member 430 as a conductive antenna connector, and a fastening member 420.

According to an embodiment, the conductive member 410 may be used as an electrical path for antenna radiation and/or an antenna radiator. For example, the wireless communication circuit of the PCB 210 may use an intermediate part of the housing 110 as the antenna radiator by use of a connection with the conductive member 410. As another example, the wireless communication circuit of the PCB 210 may use the conductive member 410 as the antenna radiator.

According to an embodiment, the conductive member 410 may be disposed in an area adjacent to the edge of the side surface 110C of the housing 110 which is at the edge of the housing 110. In one example, a part of the conductive member 410 may be disposed in an area adjacent to the conductive portion 301 of the edge of the side surface 110C. The part of the conductive member 410 may be physically connected or physically contacted with the conductive portion 301, such as to electrically connect the parts to each other. For example, the part of the conductive member 410 may be physically connected to the conductive portion 301 of the edge of the side surface 110C of the housing 110 by the fastening member 420, but it is not limited thereto. As another example, another part of the conductive member 410 may be spaced apart from the edge of the side surface 110C of the housing 110 and may not be physically connected to the conductive portion 301.

According to an embodiment, the conductive member 410 may be connected to the wireless communication circuit of the PCB 210, by the conductive connect member 430. In one example, the conductive connect member 430 interconnects the PCB 210 and the conductive member 410 to each other, and thus the conductive member 410 may be electrically connected with the wireless communication circuit disposed on the PCB 210.

According to an embodiment, the conductive connect member 430 may be disposed inside the electronic device 100 adjacent to the edge of the side surface 110C of the housing 110. In one example, the conductive connect member 430 may be disposed along the edge of the side surface 110C of the housing 110. For example, the conductive connect member 430 may extend from the PCB 210 in a first direction (e.g., +(y) direction) along the edge of the side surface 110C of the housing 110, and then bend and extend in a second direction (e.g., +(x) direction) inclined to the first direction along the curved surface formed at the edge of the side surface 110C of the housing 110.

According to an embodiment, the conductive connect member 430 may be formed of, but not limited thereto, a flexible radio frequency cable (FRC). For example, the conductive connect member 430 may be formed of a flexible PCB (FPCB).

According to an embodiment, the fastening member 420 may interconnect the conductive member 410 of the antenna assembly 200 and the conductive portion 301 of the housing 110 to each other. For example, the fastening member 420, which is disposed on a part of the conductive member 410 and a part of the conductive portion 301, may interconnect the parts of the conductive member 410 and the conductive portion 301.

According to an embodiment, the wireless communication circuit may supply power to a part of the conductive member 410, through the conductive connect member 430 of the antenna assembly 200. In one example, the wireless communication circuit may supply the power to the part of the conductive member 410 through the conductive connect member 430, and thus transmit and/or receive a signal of a designated frequency band based on an electrical path including or formed by the conductive connect member 430, the conductive member 410 electrically connected with the conductive connect member 430, and the conductive portion 301 of the housing 110 electrically connected with the conductive member 410.

According to an embodiment, the conductive member 410 may include a first conductive member 411, and a second conductive member 412 which is adjacent to the first conductive member 411.

According to an embodiment, the wireless communication circuit may use the first conductive member 411 and the second conductive member 412 as the electrical path for transmitting and/or receiving a designated signal. For example, by supplying the power to the second conductive member 412 through the conductive connect member 430, the wireless communication circuit may transmit and/or receive a signal of a designated first frequency band, based on a first electrical path including the conductive connect member 430, the first conductive member 411, the conductive portion 301 of the housing 110, and the second conductive member 412.

According to an embodiment, the designated first frequency may include a frequency band within a range of about 600 megahertz (MHz) to about 900 MHz, but it is not limited thereto. As another example, the designated first frequency may include a frequency band within a range of about 1,800 MHz to about 2,300 MHz.

According to an embodiment, the conductive member 410 may further include a third conductive member 413 disposed apart from the second conductive member 412.

According to an embodiment, the wireless communication circuit may use the third conductive member 413 as the antenna radiator. For example, by supplying the power to the third conductive member 413 through the conductive connect member 430, the wireless communication circuit may transmit and/or receive a signal of a designated second frequency band, based on a second electrical path including the conductive connect member 430 and the third conductive member 413.

According to an embodiment, the designated second frequency may include a frequency band within a range of about 2,300 MHz to about 2,700 MHz, but it is not limited thereto.

In one example, the first electrical path and the second electrical path may correspond to a loop antenna, but they are not limited thereto.

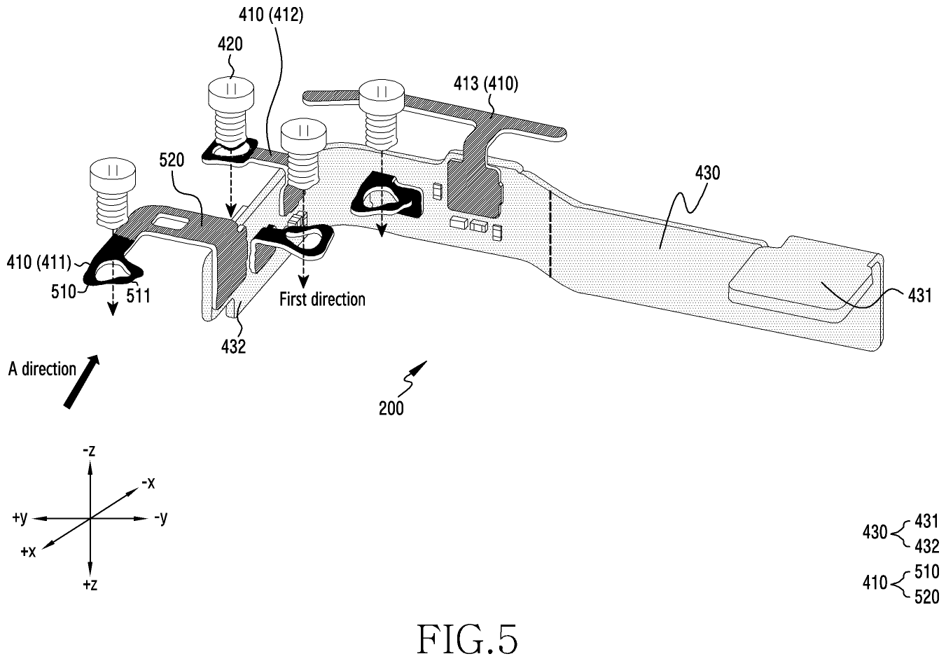

FIG. 5 is a perspective view of an antenna assembly, according to an embodiment.

According to an embodiment, FIG. 5 illustrates the antenna assembly 200 separated from a remaining structure of FIG. 4.

According to an embodiment, the antenna assembly 200 may be connected to the conductive portion 301 of the housing 110 at the conductive member 410, by one or more of the fastening member 420. For example, the antenna assembly 200 may be electrically connected to the conductive portion 301 of the housing 110, at the conductive member 410, by the fastening member 420. Since the conductive member 410 electrically connects the antenna assembly 200 to the conductive portion 301, the electronic device 100 may use the conductive portion 301 of the housing 110 as the antenna radiator.

According to an embodiment, the antenna assembly 200 may include the conductive member 410, the conductive connect member 430 which extends from and is connected with the conductive member 410, and the fastening member 420.

According to an embodiment, the conductive member 410 (e.g., like one or more of 411 and 412 in FIG. 4) may include a contact area 510 at which the conductive portion 301 of the housing 110 contacts the conductive member 410, and a connect area 520 which extends from and is connected to the conductive member 410.

According to an embodiment, the contact area 510 as a contact (e.g., an antenna contact) may be formed as a curved area. In one example, the contact area 510 as a solid portion of the contact may include a first hole 511 defined therein, where the solid portion is curved and forms a rim around the first hole 511. For example, the curved area or curved contact surface of the contact area 510 may be formed with portions having different height differences, and the first hole 511 may be formed by the portions having the height differences.

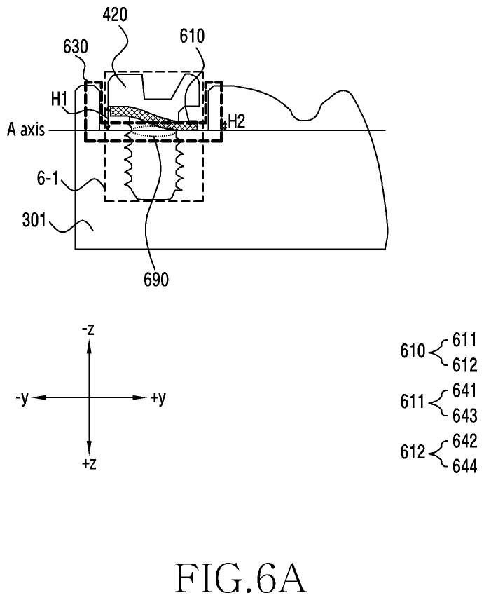

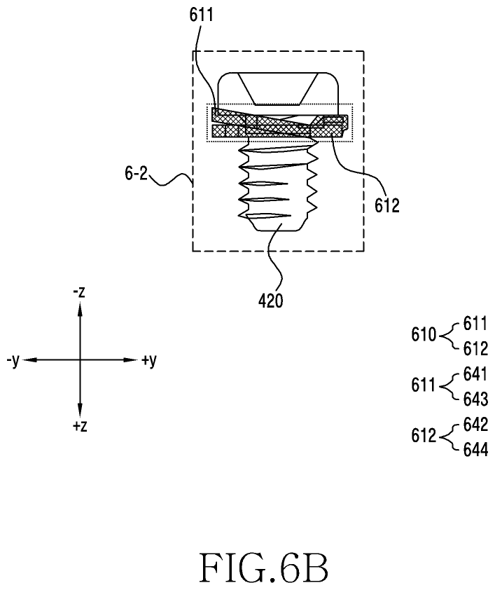

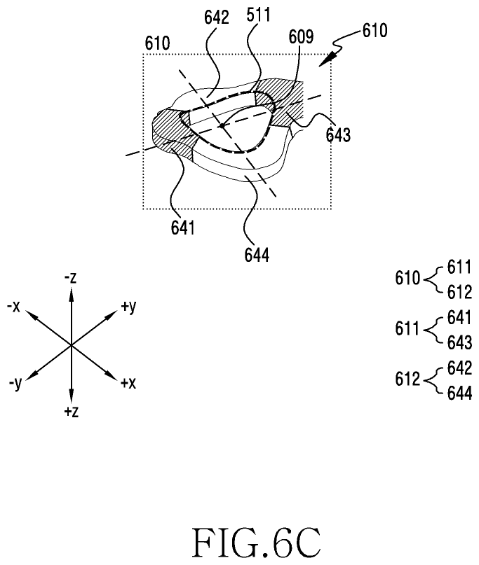

According to an embodiment, the shape of the contact area 510 having the different height difference shall be further elucidated in FIGS. 6A through FIG. 11D.

According to an embodiment, the connect area 520 may be formed as an area extending from the contact area 510. In one example, the connect area 520 may be formed as the area extending from a part of the contact area 510 and connecting with the conductive connect member 430, to connect the contact area 510 and the conductive connect member 430 to each other. For example, the connect area 520 may extend from a part of the contact area 510 to define a first part (e.g., along the x-y plane), and the connect area 520 may further extend bent from the first part to define a second part (e.g., along the z direction) facing the conductive connect member 430 such as the inner surface thereof. Since the second part of the connect area 520 faces the one surface of the conductive connect member 430, the conductive member 410 may be electrically connected to the conductive connect member 430 at the connect area 520.

According to an embodiment, the conductive portion 301 of the housing 110 may include a second hole (not shown) defined therein. In one example, the second hole may be formed as a hole corresponding to the first hole 511 of the contact area 510. In one example, the second hole may be aligned with the first hole 511. For example, the first hole 511 and the second hole may be aligned in the first direction (e.g., +(z) direction) and be open in a direction toward the front of the electronic device 100.

According to an embodiment, the fastening member 420 may be formed as a member which secures inner members disposed inside the electronic device 100. For example, the fastening member 420 may be formed as a fastening member for securing the inner members disposed inside the electronic device 100 to the conductive portion 301 of the housing 110.

According to an embodiment, the fastening member 420 may be disposed in the first hole 511 of the conductive member 410 and the second hole of the conductive portion 301. Since the fastening member 420 is disposed commonly in each hole, the fastening member 420 may secure the conductive member 410 to the conductive portion 301 of the housing 110. For example, since the first hole 511 and the second hole are aligned in the first direction (e.g., +(z) direction), the fastening member 420 may penetrate the first hole 511 and the second hole in the first direction (e.g., +(z) direction), to dispose an extended portion of the fastening member 420 which is outside one or more of the holes. According to an embodiment, as the fastening member 420 penetrates in the first direction, the fastening member 420 may secure the conductive member 410 to the conductive portion 301 of the housing 110.

According to an embodiment, the fastening member 420 may be formed in a screw structure. For example, it may be formed as the screw formed at least in part of a screw thread, but is not limited thereto.

According to an embodiment, since the fastening member 420 secures the conductive member 410 to the housing 110, at the conductive portion thereof, the conductive member 410 may be connected to the conductive portion 301 of the housing 110. For example, since the contact area 510 of the conductive member 410 contacts (e.g., physically contacts) the conductive portion 301 of the housing 110, the conductive member 410 may be electrically connected to the conductive portion 301 of the housing 110. For example, even if only the curved portion of the contact area 510 contacts the conductive portion 301 of the housing 110, the conductive member 410 may be electrically connected to the conductive portion 301.

According to an embodiment, the conductive connect member 430 may interconnect the conductive member 410 and the PCB 210 to each other. For example, the conductive connect member 430 may be connected to the PCB 210 at some area of one end 431 of the conductive connect member 430, and may be connected to the conductive member 410 at some area of the other end 432 of the conductive connect member 430.

According to an embodiment, since the conductive connect member 430 interconnects the PCB 210 and the conductive member 410 to each other, the conductive member 410 may be electrically connected to the PCB 210. For example, the conductive member 410 may be electrically connected to the PCB 210 at the wireless communication circuit disposed on the PCB 210.

In one example, since the conductive member 410 is electrically connected to the wireless communication circuit, the conductive member 410 may be used as an electrical path of the structure using the conductive portion 301 of the housing 110 as the antenna radiator. In another example, since the conductive member 410 is electrically connected to the wireless communication circuit, the conductive member 410 itself may be used as the antenna radiator (e.g., without relying on the conductive portion 301).

Referring to FIGS. 4 and 5, the conductive connect member 430 may be connected to the housing 110 and/or other inner components of the electronic device 100 by more than one of the fastening member 420. In an embodiment, the antenna assembly 200 may be connected to the housing 110 at two locations, that is, at first conductive member 411 and second conductive member 412, without being limited thereto.

FIG. 6A is an enlarged cross-sectional view of a conductive member, FIG. 6B is an enlarged view of region 6-1 in FIG. 6A and FIG. 6C is an enlarged perspective view of region 6-2 in FIG. 6B, according to an embodiment. Herein, reference to FIG. 6 may refer to one or more of FIGS. 6A to 6C.

According to an embodiment, FIG. 6 illustrates one conductive member 610 of the conductive member 410 of the antenna assembly 200 of FIG. 5. For example, FIG. 6 illustrates a cross section of the antenna assembly 200 if the antenna assembly 200 of FIG. 5 is viewed in a ‘A direction’ shown in FIG. 5. The ‘A direction’ may be a view along the x-y plane, indicated by ‘A axis’ in FIG. 6.

According to an embodiment, even if the fastening member 420 is not completely fastened to the conductive portion 301 of the housing 110, the conductive member 610 may contact (e.g., physically) the conductive portion 301 of the housing 110 by virtue of the curved contact area 510 providing one or more contact point. For example, even if the fastening member 420 is slantly inserted into a second hole 690 of the conductive portion 301 and accordingly, the fastening member 420 is incompletely seated on the conductive portion 301 of the housing 110, the curved portion of the contact area 510 of the conductive member 610 may contact the housing 110 at one or more points of contact.

According to an embodiment, as the curved portion of the contact area 510 contacts the conductive portion 301 of the housing 110, the conductive member 610 may be electrically connected to the conductive portion 301 of the housing 110.

According to an embodiment, the contact area 510 of the conductive member 610 may include a first contact portion 611, and a second contact portion 612.

According to an embodiment, the first contact portion 611 may be formed as a surface where an upper surface (e.g., a surface facing the −(z) direction) contacts a part of the fastening member 420. According to an embodiment, the second contact portion 612 may be formed as a surface where a lower surface (e.g., a surface facing the +(z) direction) contacting a part of the conductive portion 301 of the housing 110.

According to an embodiment, the first contact portion 611 and the second contact portion 612 may be formed with different heights relative to a reference. In one example, the first contact portion 611 may have a first height H1 based on an A axis (or the x-y plane). In another example, the first contact portion 611 may have a first height H1 based on one surface of the conductive portion 301 facing the contact area 510. The first height H1 may be a maximum distance along a thickness direction, from the reference, to a location along the first contact portion 611 (or the conductive member 610) which is furthest from the reference.

According to an embodiment, the first height H1 may be about 0.25 millimeter (mm), but is not limited thereto. As another example, the first height H1 may be higher than (or greater than) 0.25 mm. As yet another example, the first height H1 may be lower than 0.25 mm.

In one example, the second contact portion 612 may have a second height H2 smaller than the first height H1, based on the A axis. In another example, the first contact portion 611 may have a second height H2 lower than the first height H1 based on one surface of the conductive portion 301 facing each other.

According to an embodiment, at least one first contact portion 611 and at least one second contact portion 612 are connected to be curved and accordingly the contact area 510 may be formed as a curved surface. For example, at least one first contact portion 611 having the first height H1 may be bent and extended to be physically connected with at least one second contact portion 612 having the second height H2. For example, the contact area 510 may be formed in a twist-structure with at least one first contact portion 611 and at least one second contact portion 612. As another example, the contact area 510 may be formed in a curved-structure with at least one first contact portion 611 and at least one second contact portion 612. The second height H2 may be a minimum distance along the thickness direction, from the reference, to a location along the second contact portion 612 which is furthest from the reference.

According to an embodiment, the at least one first contact portion 611 may be formed of two first contact portions 641 and 643, and the at least one second contact portion 612 may be formed of two second contact portions 642 and 644.

Referring to FIG. 6, the first contact portion 611 according to an embodiment may include a first portion 641 and a third portion 643, and the second contact portion 612 may include a second portion 642, and a fourth portion 644. In one example, the first portion 641 and the third portion 643 may have (or define) the first height H1. In one example, the second portion 642 and the fourth portion may have (or define) the second height H2.

According to an embodiment, the second portion 642 may be formed by a portion of the conductive member 610 which is bent and extended in the first direction (e.g., the +(z) direction), to define the first portion 641 and the third portion 643. According to an embodiment, the fourth portion 644 formed in an area opposite to the second portion 642 may be formed by bending and extending in the first direction (e.g., +(z) direction) from the first portion 641 and the third portion 643.

According to an embodiment, the first portion 641 and the third portion 643 may be formed to face each other based on an arbitrary point 609 in the first hole 511. In one example, the first portion 641 and the third portion 643 may be formed, but not limited thereto, symmetrically based on the arbitrary point 609 of the first hole 511. As another example, the first portion 641 and the third portion 643 may be formed asymmetrically based on the arbitrary point 09 of the first hole 511.

The first portion 641 and the third portion 643 are exemplified as the symmetrical or asymmetrical portions, but are not limited thereto. For example, the second portion 642 and the fourth portion 644 may be formed symmetrically from an axis passing through the arbitrary point 609 of the first hole 511.

According to an embodiment, the contact area 510 may include the first hole 511 defined therein. In one example, the first hole 511 may be formed by the curved rim formed by the first contact portion 611 and the second contact portion 612. For example, an empty space may be formed surrounded by the first portion 641, the second portion 642, the third portion 643 and the fourth portion 644, and the first hole 511 may be formed in (or by) the empty space. The first hole 511 may be an enclosed opening defined by the solid portion of the conductive member 410 at the contact area 510

According to an embodiment, since the fastening member 420 passes through the first hole 511 and is inserted into the conductive portion 301, the conductive member 610 may be fixed on the conductive portion 301.

According to an embodiment, even if the contact area 510 of the conductive member 610 is formed as the portion having the different heights and the fastening member 420 is inserted only in part into the conductive portion 301, the conductive member 610 may contact the conductive portion 301 at one or more point. For example, even if the fastening member 420 is inserted at an angle into the second hole 690 formed in the conductive portion 301 of the housing 110, the conductive member 610 may contact the conductive portion 301 by the curved contact area 510. For example, even if the fastening member 420 is incompletely inserted into the second hole 690 of the conductive portion 301, the lower surfaces (e.g., the surfaces facing the +(z) direction) of the second portion 642 and the fourth portion 644 of the second contact portion 612 having the second height H2 may contact the conductive portion 301 of the housing 110. Here, the conductive member 610 may contact the intermediate housing at one or more contact points defined along the lower surface of the conductive member 610 (e.g., at the second contact portion 612).

According to an embodiment, since a part of the second contact portion 612 of the conductive member 610 contacts (e.g., physically) the conductive portion 301, the conductive member 610 may be electrically connected with the conductive portion 301.

According to an embodiment, since the conductive member 610 is electrically connected with the conductive portion 301, the conductive member 610 may be used as an electrical path for transmitting and/or receiving a signal of a designated frequency band. For example, by supplying the power to the conductive member 610 connected to the conductive connect member 430, the wireless communication circuit may transmit and/or receive a signal of the designated frequency band based on the electrical path including the conductive connect member 430, the conductive member 610 (referring to the conductive member 410 in FIG. 4, for example), and the conductive portion 301.

Table 1 shows a resistance value of the conductive member 610 according to the height of the fastening member 420 for the fastening member 420 not completely inserted into the second hole 690 of the conductive portion 301, based on the A axis.

| | | | | | A structure | A structure | A structure |
|---|---|---|---|---|---|---|---|
| | | | | | having the | having the | having the |
| | | A | A flat | A flat | different | different | different |
| | | reference | structure | structure | height | height | height |
| state | | value | 0.2 mm | 0.25 mm | 0.15 mm | 0.2 mm | 0.25 mm |
| Band 1 | TRP | 15.24 | 13.75 | 5.55 | 15.27 | 15.17 | 15.02 |
| Band 2 | TRP | 15.59 | 14.26 | 5.34 | 15.6 | 15.54 | 15.37 |
| Band 3 | TRP | 17.01 | 16.86 | 16.94 | 16.91 | 16.93 | 16.86 |
| Band 4 | TRP | 17.74 | 17.42 | 15.45 | 17.71 | 17.73 | 17.64 |

| | | | | | | |
|---|---|---|---|---|---|---|
| resistance value | 0.1 | 3.2 | Open | 0.1 | 0.2 | 0.3 |
| [Ω] | | | | | | |

The vertical-axis legend of (state column in Table 1) is a legend indicating a total radiation power (TRP) of the antenna per frequency band, and the measured (electrical) resistance value in Ohms (Ω). In addition, the horizontal-axis legend is a legend indicating the incompletely seated height of the fastening member 420 according to structure of the contact area 510 (e.g., being flat or having different heights). The vertical axis range is the maximum antenna for each frequency band.

If the difference between the resistance value of the conductive member 610 and the resistance value of the reference value increases, the antenna performance may be degraded.

According to an embodiment, the reference value indicates a resistance value of the conductive member 610 measured, if the fastening member 420 is completely inserted and the conductive member 610 and the conductive portion 301 completely face each other to have a maximum contact with each other.

According to an embodiment, in a conductive member including a contact area formed in a flat structure, the resistance value measured in the flat conductive member may increase as the incompletely seated height of the fastening member 420 increases (e.g., third to fourth columns in Table 1). For example, if the incompletely seated height of the fastening member 420 is 0.25 mm, the measured resistance value is open, and the electrical signal may not flow through the conductive member and the conductive portion 301.

According to an embodiment, in the conductive member 610 including the contact area 510 formed in the structure having the different heights, if the incompletely seated height of the fastening member 420 is 0.25 mm or less (fifth to seventh columns above), the resistance value measured at the conductive member 610 may not substantially differ from the reference value. In one example, the resistance value measured in the conductive member 610 if the incompletely seated height of the fastening member 420 is 0.25 mm or less may be substantially the same as the resistance value measured in the conductive member 610 if the fastening member 420 is completely inserted. For example, in the conductive member 610 including the contact area 510 formed in the structure having the different height, if the incompletely seated height of the fastening member 420 and the conductive portion 301 is 0.25 mm, the measured resistance value is 0.3Ω, which may not substantially differ from the reference resistance value of 0.1Ω.

Referring to Table 1 according to an embodiment, even if the fastening member 420 is incompletely seated in the second hole 690 of the conductive portion 301, the conductive member 610 having the curved contact area 510 may exhibit substantially the same antenna performance as the case where the fastening member 420 is completely inserted. For example, even if the fastening member 420 is incompletely seated in the second hole 690 of the conductive portion 301, at least one second contact portion 612 of the contact area 510 faces one surface of the conductive portion 301 and thus the conductive member 610 may be electrically connected to the conductive portion 301. That is, since the curved lower surface of the conductive member 610 has surface portions which face in different directions and are non-coplanar with each other so as to be in different planes, an interface of one or more of the surface portions with the conductive portion is increased.

According to an embodiment, at least a part of the conductive member 610 may be formed of a material having elasticity or a material which is easily deformed. For example, the contact area 510 of the conductive member 610 may be formed of stainless use steel (SUS) as being relatively easily deformable, which is not limited thereto. As another example, the conductive member 610 may be formed of copper as being relatively easily deformable.

According to an embodiment, since the conductive member 610 is formed of a material which is elastic or has deformability, a curved shape of the conductive member 610 may be flattened if the fastening member 420 is completely inserted into the second hole 690 of the conductive portion 301. For example, if the fastening member 420 is completely inserted, the contact area 510 which is curved may be flattened due to the deformable material at the contact area 510.

According to an embodiment, if the fastening member 420 is incompletely fastened or inserted in part, the contact area 510 is formed in the curved shape and accordingly a part of the contact area 510 of the conductive member 610 may keep the contact with the conductive portion 301. For example, referring to FIG. 6, the second contact portion 612 of the contact area 510 may contact the conductive portion 301 even if only a part of the fastening member 420 is inserted into the aligned holes to provide a pressing force between the conductive member 610 and the intermediate housing.

According to an embodiment, since at least a part of the second contact portion 612 of the contact area 510 contacts the conductive portion 301, the conductive member 610 and the conductive portion 301 may be electrically connected.

According to an embodiment, by forming the conductive member 610 with a deformable material, the conductive member 610 may not be damaged even if the conductive member 610 is flattened.

According to an embodiment, since the conductive member 610 is electrically connected to the conductive portion 301 by the contact area 510, the conductive member 610 may be used as the electrical path for transmitting and/or receiving a signal of the designated frequency band.

According to an embodiment, the conductive portion 301 of the housing 110 may include (or define) a recess 630 corresponding to the second hole 690. For example, a part of the conductive member 610 and/or at least a part of the fastening member 402 may be disposed in the recess 630 of the conductive portion 301 of the housing 110. If the recess 630 is included in the conductive portion 301 of the housing 110 and at least a part of the conductive member 610 and/or the fastening member 420 are disposed in the recess 630, a total thickness of the housing 110 may be reduced compared to a structure in which at least a part of the conductive member 610 and/or the fastening member 420 are not disposed in the recess 630 such as to extend out of recess 630.

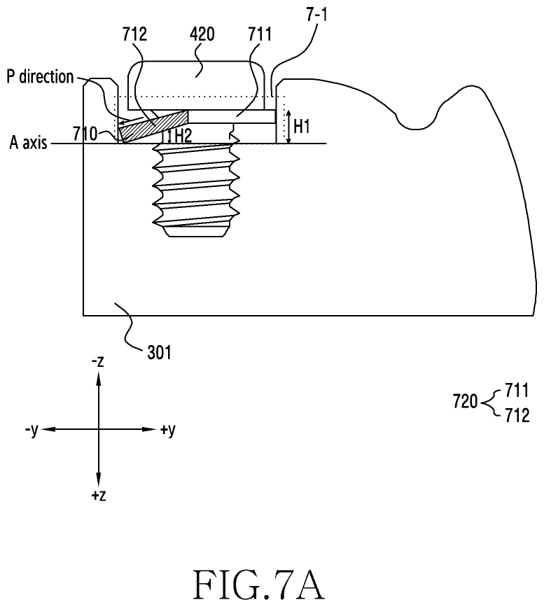

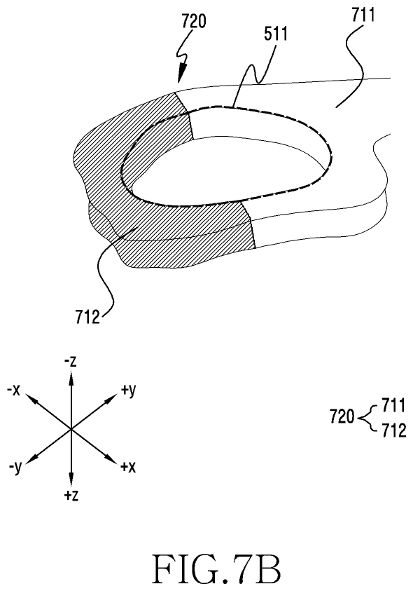

FIG. 7A is an enlarged cross-section view of a conductive member, and FIG. 7B is an enlarged perspective view of region 7-1 in FIG. 7A, according to an embodiment. Herein, reference to FIG. 7 may refer to one or more of FIGS. 7A and 7B.

According to an embodiment, unlike the conductive member 610 of FIG. 6, the conductive member 710 of FIG. 7 may be formed with a part of the contact area 720 which is inclined.

According to an embodiment, even if the fastening member 420 is incompletely seated on the conductive portion 301, the conductive member 710 may be electrically connected to the conductive portion 301, by virtue of the inclined part of the contact area 720.

According to an embodiment, the contact area 720 of the conductive member 710 may include a first contact portion 711 and a second contact portion 712.

In one example, the first contact portion 711 may have a first height H1 based on the A axis. In one example, the first contact portion 711 may be formed as a flat area having the constant first height H1 based on (or relative to) one surface of the conductive portion 301. For example, one surface of the first contact portion 711 may contact the fastening member 420. For example, an upper surface of the first contact portion 711 may face the fastening member 420.

In one example, the second contact portion 712 may be formed as a contact portion having a varying height. For example, the second contact portion 712 may be formed as an area extending from the first contact portion 711 at an angle. For example, the second contact portion 712 may be formed as an area in which the second height H2 gradually decreases from the first contact portion 711 toward the first direction (e.g., P direction) based on one surface of the conductive portion 301. For example, the second contact portion 712 may be formed as an area in which the second height H2 gradually decreases as it extends from the first contact portion 711 toward the A axis along the thickness direction.

According to an embodiment, if the fastening member 420 is inserted into the conductive member 710 and the conductive portion 301, at least a part of a lower surface of the second contact portion 712 may contact the conductive portion 301.

According to an embodiment, even if the fastening member 420 is incompletely fastened to the second hole (not shown) of the conductive portion 301, a distal end of the conductive member 710 which is at the second contact portion 712 having the second height H2 may contact the conductive portion 301 of the housing 110. According to an embodiment, since one end of the second contact portion 712 having the second height H2 contacts the conductive portion 301 of the housing 110, the conductive member 710 may be electrically connected to the conductive portion 301.

According to an embodiment, since the conductive member 710 is electrically connected to the conductive portion 301, the conductive member 710 may be used as the electrical path for transmitting and/or receiving a signal of the designated frequency band. For example, by supplying power to the conductive member 710 connected with the conductive connect member 430, the wireless communication circuit may transmit and/or receive a signal of the designated frequency band based on the electrical path including the conductive connect member 430, the conductive member 710 (referring to the conductive member 410 in FIG. 4, for example), and the conductive portion 301.

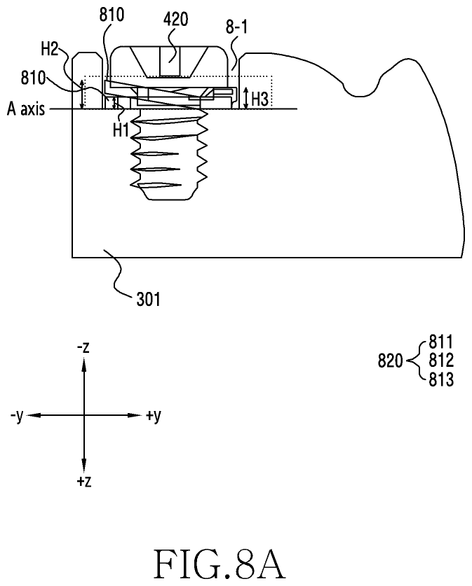

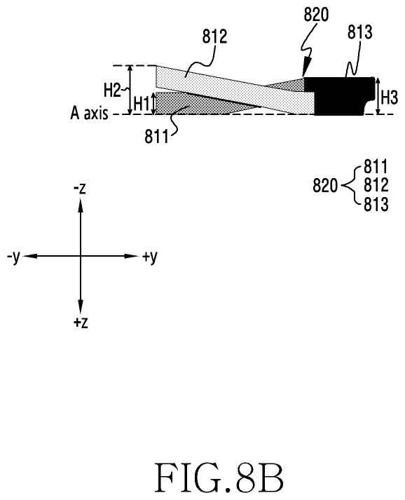

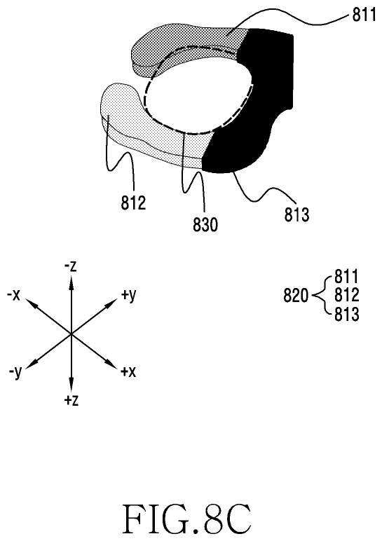

FIG. 8A is an enlarged cross-sectional view of a conductive member, FIG. 8B is an enlarged view of region 8-1 in FIG. 8A, and FIG. 8C is an enlarge perspective view of region 8-1 in FIG. 8A. Herein, reference to FIG. 8 may refer to one or more of FIGS. 8A to 8C.

Unlike the conductive member 610 of FIG. 6 and the conductive member 710 of FIG. 7, a conductive member 810 of FIG. 8 may include a contact area 820 in which a complete hole is not formed.

According to an embodiment, since the contact area 820 of the conductive member 810 is not formed as having an enclosed hole, the conductive member 810 may be formed in a structure for adjusting repelling force through the fastening using the fastening member 420.

According to an embodiment, the contact area 820 of the conductive member 810 may include one first contact portion 811 and one second contact portion 812.

According to an embodiment, the contact area 820 may further include a third contact portion 813. In one example, the third contact portion 813 may be formed in a flat shape. For example, the third contact portion 813 may have a third height H3 based on the A axis. For example, the third contact portion 813 may be formed with the constant third height H3 based on one surface of the conductive portion 301.

According to an embodiment, the first contact portion 811 may extend from one end of the third contact portion 813. In one example, the first contact portion 811 may be slantly extended while gradually increasing the inclination at one end of the third contact portion 813. For example, the first contact portion 811 may be formed with the first height H1 which gradually increases from one end of the third contact portion 813 based on one surface of the conductive portion 301. For example, the first contact portion 811 may be formed, from one end of the third contact portion 813, with the first height H1 which gradually increases based on the A axis A to define a first distal end of the the contact area 820.

According to an embodiment, the second contact portion 812 may extend from the other end of the third contact portion 813 which is opposite to the one end. In one example, the second contact portion 812 may be inclined and extended while gradually decreasing the inclination at the other end of the third contact portion 813. For example, the second contact portion 812 may be formed with the second height H2 gradually decreasing in height from the other end of the third contact portion 813 based on one surface of the conductive portion 301. For example, the second contact portion 812 may be formed with the second height H2 which gradually decreases in height based on the A axis, from the other end of the third contact portion 813, to define a second distal end of the the contact area 820. In cross-section, the first contact portion 811 and the second contact portion 812 may cross each other (refer to FIG. 8B).

According to an embodiment, unlike the contact area 510 of FIG. 6 and the contact area 720 of FIG. 7, the first contact portion 811 and the second contact portion 812 of the contact area 820 of FIG. 8 may be physically disconnected by a gap to provide an open hole of the contact area 820. In one example, since the first contact portion 811 and the second contact portion 812 are physically disconnected at distal ends thereof, the first hole 830 may not be formed in the complete circle to have an enclosed shape. For example, the contact area 820 may be formed in an open-loop shape including an opening area in part.

According to an embodiment, if the conductive member 810 is fastened to the conductive portion 301 by the fastening member 420, the open-loop shape of the contact area 820 may reduce concentration of internal stress on the contact area 820 of the conductive member 810. For example, if the fastening member 420 is rotated, the contact area 820 in the open-loop shape is not caught on the fastening member 420 and thus the internal stress may not be concentrated inside the contact area 820.

According to an embodiment, durability of the conductive member 810 may be attained, by reducing the stress concentration inside the open-looped contact area 820. According to an embodiment, the quality of the antenna performance may be improved by obtaining the durability of the conductive member 810.

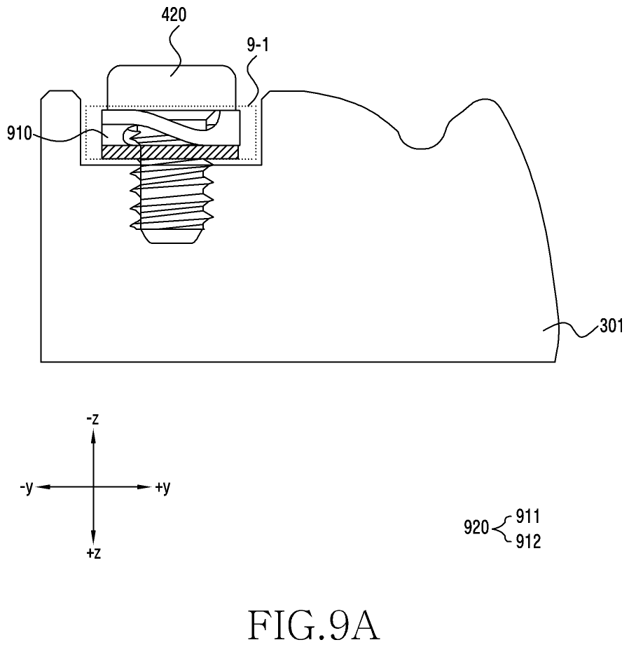

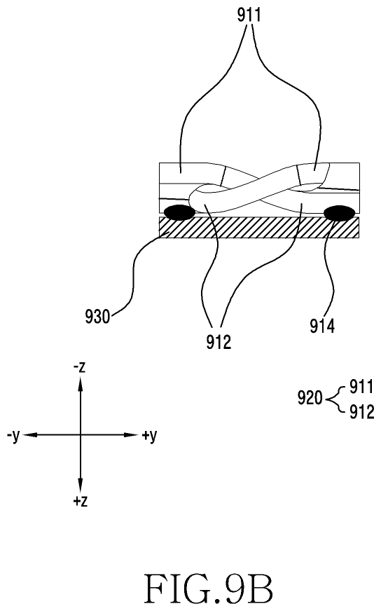

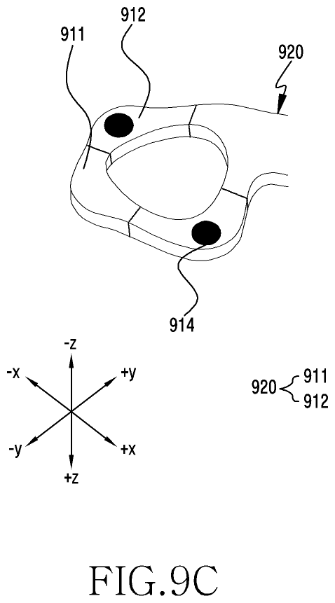

FIG. 9A is an enlarged cross-sectional view of a conductive member, FIG. 9B is an enlarged view of region 9-1 in FIG. 9A, and FIG. 9C is an enlarged perspective view of region 9-1 in FIG. 9A, according to an embodiment. Herein, reference to FIG. 9 may refer to one or more of FIGS. 9A to 9C.

According to an embodiment, unlike the electronic device 100 including the conductive member 810 of FIG. 8, the electronic device 100 of FIG. 9 may further include a conductive support member 930.

According to an embodiment, since the electronic device 100 further includes the conductive support member 930, the conductive member 910 may be electrically fastened with the conductive portion 301 of the housing 110 with more stability.

According to an embodiment, since the electronic device 100 further includes the conductive support member 930, the conductive member 910 may be physically fastened with the conductive portion 301 of the housing 110 with more contact.

According to an embodiment, the conductive member 910 may further include a conductive support member 930. In one example, the conductive support member 930 may be disposed on one surface of the contact area 920 of the conductive member 910. For example, the conductive support member 930 may be disposed on one surface of the contact area 920 of the conductive member 910 facing the first direction (e.g., the +(z) direction). For example, the conductive support member 930 may be disposed between the conductive member 910 and the conductive portion 301, if the conductive member 910 is fastened to the conductive portion 301 of the housing 110 by the fastening member 420.

According to an embodiment, the conductive support member 930 may be attached to the conductive member 910. In one example, the conductive support member 930 may be attached to one surface of the contact area 920 of the conductive member 910. For example, the contact area 920 of the conductive member 910 may include a first contact portion 911, and a second contact portion 912 bending and extending from the first contact portion 911, and the conductive support member 930 may be attached to the second contact portion 912 by a conductive adhesive member 914.

According to an embodiment, the conductive adhesive member 914 may include a welding member (e.g., a weld). In one example, the conductive support member 930 and the conductive member 910 may be electrically connected to each other by the welding member, to increase electrical conductivity within the contact area 920. For example, by welding one area of the second contact portion 912 to a corresponding area of the conductive support member 930 using the welding member, the conductive member 910 may be electrically connected with the conductive support member 930.

According to an embodiment, the conductive adhesive member 914 may include conductive powder. For example, by applying the conductive powder between one area of the second contact portion 912 and the conductive support member 930, the conductive member 910 may be electrically connected to the conductive support member 930.

According to an embodiment, since the conductive member 910 and the conductive support member 930 are electrically connected to each other within the contact area 920, the conductive member 910 may achieve more electrical stability with the conductive portion 301 of the housing 110. For example, since the entire one surface of the conductive support member 930 faces the conductive portion 301 and thus the conductive member 910 may be electrically stably fastened with the conductive portion 301.

According to an embodiment, the conductive support member 930 may be formed as a plate having a constant thickness. In one example, the conductive support member 930 may be formed as a flat plate.

According to an embodiment, since the conductive support member 930 is formed as the flat plate, a contact surface between the contact area 920 at the conductive support member 930, and the conductive portion 301, may increase. According to an embodiment, by increasing the contact surface between the conductive support member 930 and the conductive portion 301, the conductive member 910 may be electrically stably fastened with the conductive portion 301.

According to an embodiment, as the electrical connection between the conductive member 910 and the conductive portion 301 increases, the resistance value formed between the conductive member 910 and the conductive portion 301 does not increase and accordingly the degradation of the antenna performance may not occur.

In addition, since the conductive support member 930 is coupled to the conductive member 910 by a direct bond (e.g., the weld), the conductive member 910 including the conductive support member 930 may achieve high durability against the deformation or the damage 0.

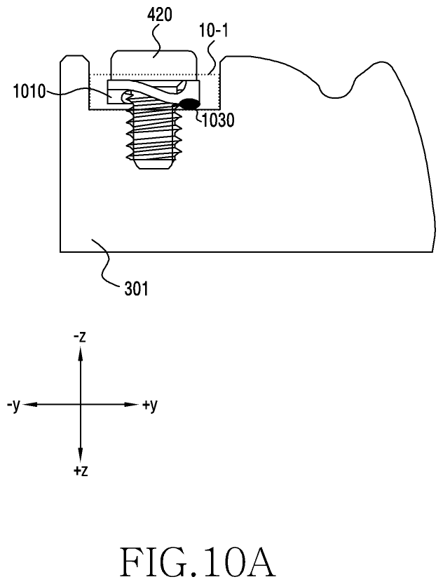

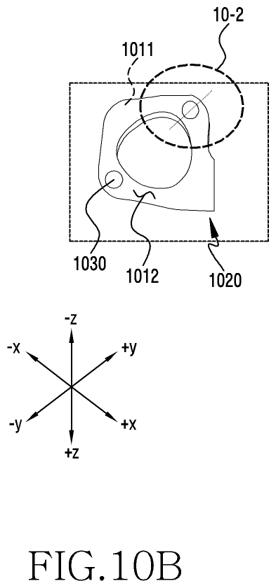

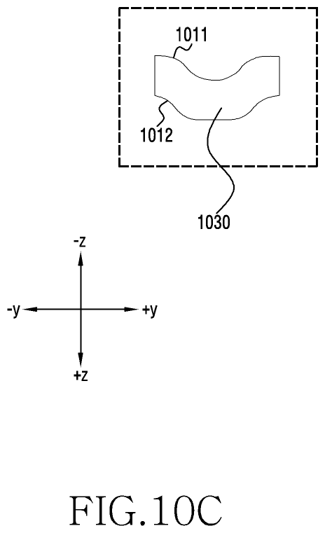

FIG. 10A is an enlarged cross-sectional view of a conductive member, FIG. 10B is an enlarged perspective view of region 10-1 in FIG. 10A, and FIG. 10C is a cross-sectional view of region 10-2 in FIG. 10B, according to an embodiment. Herein, reference to FIG. 10 may refer to one or more of FIGS. 10A to 10C.

According to an embodiment, a conductive member 1010 of FIG. 10 may further include a protrusion 1030 unlike the conductive member 910 of FIG. 9.

According to an embodiment, since the conductive member 1010 further includes the protrusion 1030, the electrical connection between the conductive member 1010 and the conductive portion 301 of the housing 110 may achieve more stable fastening.

According to an embodiment, a contact area 1020 of the conductive member 1010 may include a first contact portion 1011 and a second contact portion 1012. For example, the first contact portion 1011 may be formed as a surface in which an upper surface (e.g., a surface facing the −(z) direction) contacts a part of the fastening member 420. For example, the second contact portion 1012 may be formed as a surface in which a lower surface (e.g., a surface facing the +(z) direction) contacts a part of the conductive portion 301 of the housing 110.

According to an embodiment, the protrusion 1030 may be formed on one surface of the conductive member 1010. In one example, the protrusion 1030 may be formed on one surface of the contact area 1020 of the conductive member 1010. For example, the protrusion 1030 may be formed on one surface of the second contact portion 1012 of the contact area 1020 facing the front of the electronic device 100. For example, the protrusion 1030 may be formed by protruding from one surface of the second contact portion 1012 in the first direction (e.g., the +(z) direction).

According to an embodiment, since the protrusion 1030 is formed, the conductive member 1010 may contact the conductive portion 301, even if the fastening member 420 is incompletely seated. For example, even if the fastening member 420 is inserted at an angle into a first hole (e.g., 511 of FIG. 5) of the conductive member 1010, and a second hole (e.g., 690 of FIG. 6) of the conductive portion 301, the conductive member 1010 may physically contact with the conductive portion 301 by the protrusion 1030.

According to an embodiment, the conductive member 1010 may physically contact the conductive portion 301 by the protrusion 1030, and thus the conductive member 1010 may be electrically connected with the conductive portion 301.

Since the conductive member 1010 physically contacts the conductive portion 301, the resistance value formed between the conductive member 1010 and the conductive portion 301 does not increase and accordingly the antenna performance degradation may not occur.

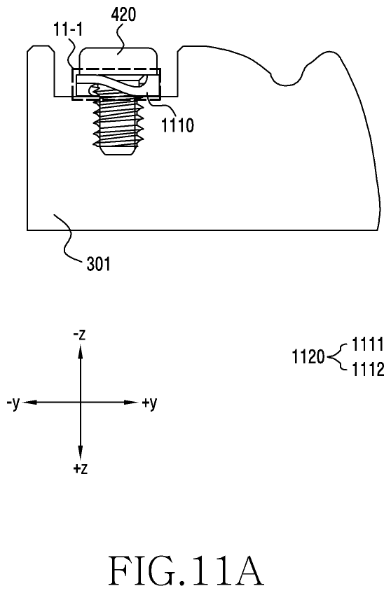

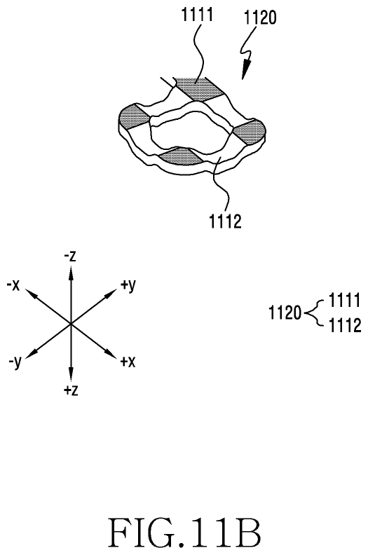

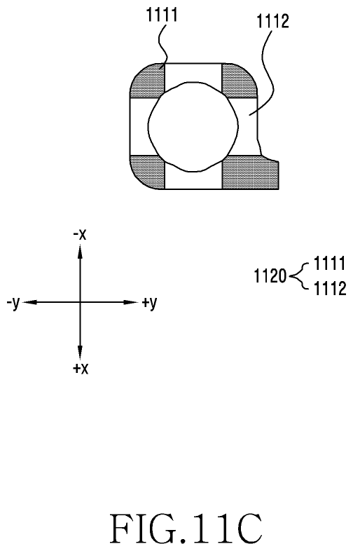

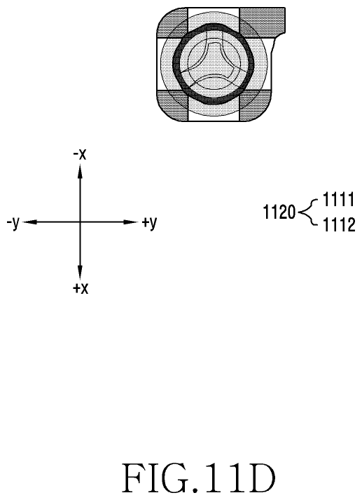

FIG. 11A is an enlarged cross-sectional view of a conductive member, FIG. 11B is an enlarged perspective view of region 11-1 in FIG. 11A, FIGS. 11C and 11D are enlarged plan views of region 11-1 in FIG. 11A, according to an embodiment. FIG. 11D illustrates a plan view of the conductive member having the fastening member 420 coupled thereto. Herein, reference to FIG. 11 may refer to one or more of FIGS. 11A to 11D.

According to an embodiment, unlike the conductive member 610 of FIG. 6, a conductive member 1110 of FIG. 11 may include a plurality of first contact portions 1111 and a plurality of second contact portions 1112.

According to an embodiment, by forming the plurality of the first contact portions 1111 and the plurality of the second contact portions 1112, the conductive member 1110 may be electrically strongly formed with the conductive portion 301.

According to an embodiment, the plurality of the first contact portions 1111 may include four contact portions at which the conductive member 1110 contacts the fastening member 420. According to an embodiment, the plurality of the second contact portions 1112 may include four contact portions at which the conductive member 1110 contacts the conductive portion 301.

According to an embodiment, since the plurality of the second contact portions includes the four second contact portions 1112, the conductive member 1110 may be electrically stably fastened with the conductive portion 301. In one example, if the fastening member 420 is incompletely seated, the contact portion between the conductive member 1110 and the conductive portion 301 increases and thus the conductive member 1110 and the conductive portion 301 may be electrically safely fastened. For example, even if the fastening member 420 is inserted at an angle into the direction of the hole, the four second contact portions 1112 of the conductive member 1110 may be electrically more stably fastened with the conductive portion 301.

According to an embodiment, the contact portion 1120 includes the four first contact portions 1111 and the four second contact portions 1112 by way of example, but is not limited thereto. For example, the contact portion 1120 may include six first contact portions 1111 and six second contact portions 1112.

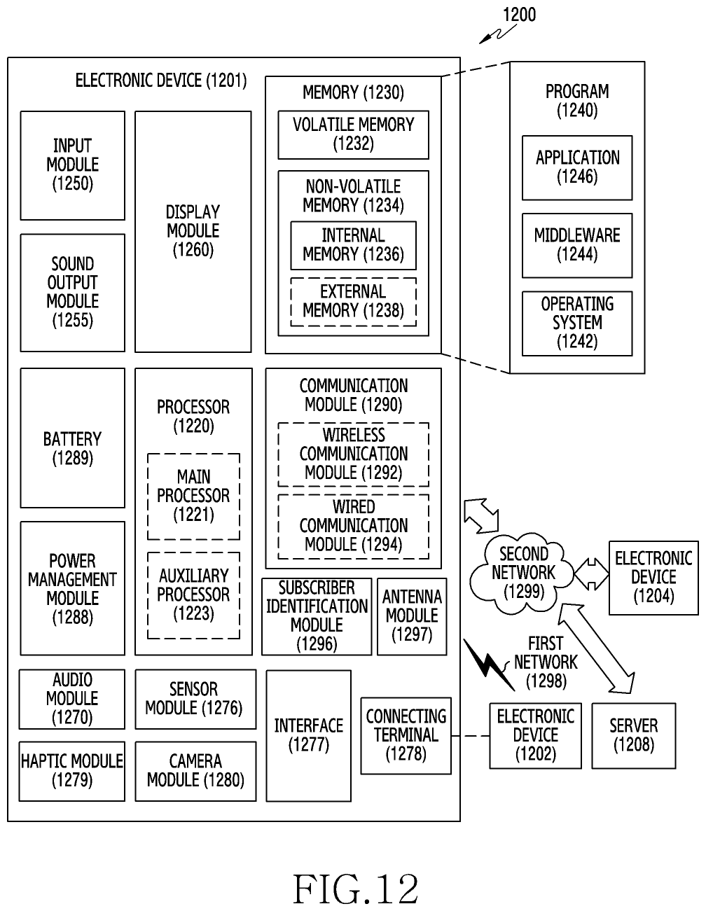

FIG. 12 is a block diagram illustrating an electronic device 1201 in a network environment 1200 according to various embodiments.

Referring to FIG. 12, the electronic device 1201 in the network environment 1200 may communicate with an electronic device 1202 via a first network 1298 (e.g., a short-range wireless communication network), or at least one of an electronic device 1204 or a server 1208 via a second network 1299 (e.g., a long-range wireless communication network). According to an embodiment, the electronic device 1201 may communicate with the electronic device 1204 via the server 1208. According to an embodiment, the electronic device 1201 may include a processor 1220, memory 1230, an input module 1250, a sound output module 1255, a display module 1260, an audio module 1270, a sensor module 1276, an interface 1277, a connecting terminal 1278, a haptic module 1279, a camera module 1280, a power management module 1288, a battery 1289, a communication module 1290, a subscriber identification module (SIM) 1296, or an antenna module 1297. In embodiments, at least one of the components (e.g., the connecting terminal 1278) may be omitted from the electronic device 1201, or one or more other components may be added in the electronic device 1201. In embodiments, some of the components (e.g., the sensor module 1276, the camera module 1280, or the antenna module 1297) may be implemented as a single component (e.g., the display module 1260).

The processor 1220 may execute, for example, software (e.g., a program 1240) to control at least one other component (e.g., a hardware or software component) of the electronic device 1201 coupled with the processor 1220, and may perform various data processing or computation. According to one embodiment, as at least part of the data processing or computation, the processor 1220 may store a command or data received from another component (e.g., the sensor module 1276 or the communication module 1290) in volatile memory 1232, process the command or the data stored in the volatile memory 1232, and store resulting data in non-volatile memory 1234. According to an embodiment, the processor 1220 may include a main processor 1221 (e.g., a central processing unit (CPU) or an application processor (AP)), or an auxiliary processor 1223 (e.g., a graphics processing unit (GPU), a neural processing unit (NPU), an image signal processor (ISP), a sensor hub processor, or a communication processor (CP)) that is operable independently from, or in conjunction with, the main processor 1221. For example, when the electronic device 1201 includes the main processor 1221 and the auxiliary processor 1223, the auxiliary processor 1223 may be adapted to consume less power than the main processor 1221, or to be specific to a specified function. The auxiliary processor 1223 may be implemented as separate from, or as part of the main processor 1221.

The auxiliary processor 1223 may control at least some of functions or states related to at least one component (e.g., the display module 1260, the sensor module 1276, or the communication module 1290) among the components of the electronic device 1201, instead of the main processor 1221 while the main processor 1221 is in an inactive (e.g., sleep) state, or together with the main processor 1221 while the main processor 1221 is in an active state (e.g., executing an application). According to an embodiment, the auxiliary processor 1223 (e.g., an image signal processor or a communication processor) may be implemented as part of another component (e.g., the camera module 1280 or the communication module 1290) functionally related to the auxiliary processor 1223. According to an embodiment, the auxiliary processor 1223 (e.g., the neural processing unit) may include a hardware structure specified for artificial intelligence model processing. An artificial intelligence model may be generated by machine learning. Such learning may be performed, e.g., by the electronic device 1201 where the artificial intelligence is performed or via a separate server (e.g., the server 1208). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1230 may store various data used by at least one component (e.g., the processor 1220 or the sensor module 1276) of the electronic device 1201. The various data may include, for example, software (e.g., the program 1240) and input data or output data for a command related thereto. The memory 1230 may include the volatile memory 1232 or the non-volatile memory 1234.

The program 1240 may be stored in the memory 1230 as software, and may include, for example, an operating system (OS) 1242, middleware 1244, or an application 1246.

The input module 1250 may receive a command or data to be used by another component (e.g., the processor 1220) of the electronic device 1201, from the outside (e.g., a user) of the electronic device 1201. The input module 1250 may include, for example, a microphone, a mouse, a keyboard, a key (e.g., a button), or a digital pen (e.g., a stylus pen).

The sound output module 1255 may output sound signals to the outside of the electronic device 1201. The sound output module 1255 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1260 may visually provide information to the outside (e.g., a user) of the electronic device 1201. The display module 1260 may include, for example, a display, a hologram device, or a projector and control circuitry to control a corresponding one of the display, hologram device, and projector. According to an embodiment, the display module 1260 may include a touch sensor adapted to detect a touch, or a pressure sensor adapted to measure the intensity of force incurred by the touch.

The audio module 1270 may convert a sound into an electrical signal and vice versa. According to an embodiment, the audio module 1270 may obtain the sound via the input module 1250, or output the sound via the sound output module 1255 or a headphone of an external electronic device (e.g., an electronic device 1202) directly (e.g., wiredly) or wirelessly coupled with the electronic device 1201.

The sensor module 1276 may detect an operational state (e.g., power or temperature) of the electronic device 1201 or an environmental state (e.g., a state of a user) external to the electronic device 1201, and then generate an electrical signal or data value corresponding to the detected state. According to an embodiment, the sensor module 1276 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1277 may support one or more specified protocols to be used for the electronic device 1201 to be coupled with the external electronic device (e.g., the electronic device 1202) directly (e.g., wiredly) or wirelessly. According to an embodiment, the interface 1277 may include, for example, a high definition multimedia interface (HDMI), a universal serial bus (USB) interface, a secure digital (SD) card interface, or an audio interface.

A connecting terminal 1278 may include a connector via which the electronic device 1201 may be physically connected with the external electronic device (e.g., the electronic device 1202). According to an embodiment, the connecting terminal 1278 may include, for example, a HDMI connector, a USB connector, a SD card connector, or an audio connector (e.g., a headphone connector).

The haptic module 1279 may convert an electrical signal into a mechanical stimulus (e.g., a vibration or a movement) or electrical stimulus which may be recognized by a user via his tactile sensation or kinesthetic sensation. According to an embodiment, the haptic module 1279 may include, for example, a motor, a piezoelectric element, or an electric stimulator.

The camera module 1280 may capture a still image or moving images. According to an embodiment, the camera module 1280 may include one or more lenses, image sensors, image signal processors, or flashes.

The power management module 1288 may manage power supplied to the electronic device 1201. According to one embodiment, the power management module 1288 may be implemented as at least part of, for example, a power management integrated circuit (PMIC).

The battery 1289 may supply power to at least one component of the electronic device 1201. According to an embodiment, the battery 1289 may include, for example, a primary cell which is not rechargeable, a secondary cell which is rechargeable, or a fuel cell.

The communication module 1290 may support establishing a direct (e.g., wired) communication channel or a wireless communication channel between the electronic device 1201 and the external electronic device (e.g., the electronic device 1202, the electronic device 1204, or the server 1208) and performing communication via the established communication channel. The communication module 1290 may include one or more communication processors that are operable independently from the processor 1220 (e.g., the application processor (AP)) and supports a direct (e.g., wired) communication or a wireless communication. According to an embodiment, the communication module 1290 may include a wireless communication module 1292 (e.g., a cellular communication module, a short-range wireless communication module, or a global navigation satellite system (GNSS) communication module) or a wired communication module 1294 (e.g., a local area network (LAN) communication module or a power line communication (PLC) module). A corresponding one of these communication modules may communicate with the external electronic device via the first network 1298 (e.g., a short-range communication network, such as Bluetooth™, wireless-fidelity (Wi-Fi) direct, or infrared data association (IrDA)) or the second network 1299 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1292 may identify and authenticate the electronic device 1201 in a communication network, such as the first network 1298 or the second network 1299, using subscriber information (e.g., international mobile subscriber identity (IMSI)) stored in the subscriber identification module 1296.

The wireless communication module 1292 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1292 may support a high-frequency band (e.g., the mmWave band) to achieve, e.g., a high data transmission rate. The wireless communication module 1292 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1292 may support various requirements specified in the electronic device 1201, an external electronic device (e.g., the electronic device 1204), or a network system (e.g., the second network 1299). According to an embodiment, the wireless communication module 1292 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 1297 may transmit or receive a signal or power to or from the outside (e.g., the external electronic device) of the electronic device 1201. According to an embodiment, the antenna module 1297 may include an antenna including a radiating element composed of a conductive material or a conductive pattern formed in or on a substrate (e.g., a printed circuit board (PCB)). According to an embodiment, the antenna module 1297 may include a plurality of antennas (e.g., array antennas). In such a case, at least one antenna appropriate for a communication scheme used in the communication network, such as the first network 1298 or the second network 1299, may be selected, for example, by the communication module 1290 (e.g., the wireless communication module 1292) from the plurality of antennas. The signal or the power may then be transmitted or received between the communication module 1290 and the external electronic device via the selected at least one antenna. According to an embodiment, another component (e.g., a radio frequency integrated circuit (RFIC)) other than the radiating element may be additionally formed as part of the antenna module 1297. According to various embodiments, the antenna module 1297 may form a mm Wave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mm Wave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1201 and the external electronic device 1204 via the server 1208 coupled with the second network 1299. Each of the electronic devices 1202 or 1204 may be a device of a same type as, or a different type, from the electronic device 1201. According to an embodiment, all or some of operations to be executed at the electronic device 1201 may be executed at one or more of the external electronic devices 1202, 1204, or 1208. For example, if the electronic device 1201 should perform a function or a service automatically, or in response to a request from a user or another device, the electronic device 1201, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1201. The electronic device 1201 may provide the outcome, with or without further processing of the outcome, as at least part of a reply to the request. To that end, a cloud computing, distributed computing, mobile edge computing (MEC), or client-server computing technology may be used, for example. The electronic device 1201 may provide ultra low-latency services using, e.g., distributed computing or mobile edge computing. In another embodiment, the external electronic device 1204 may include an internet-of-things (IoT) device. The server 1208 may be an intelligent server using machine learning and/or a neural network. According to an embodiment, the external electronic device 1204 or the server 1208 may be included in the second network 1299. The electronic device 1201 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements.

It will be understood that when an element is referred to as being related to another element such as being “on” another element, it can be directly on the other element or intervening elements may be present therebetween. In contrast, when an element is referred to as being related to another element such as being “directly on” another element, there are no intervening elements present.

It is to be understood that a singular form of a noun corresponding to an item may include one or more of the things, unless the relevant context clearly indicates otherwise. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.”

As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

As used herein, such terms as “1st” and “2nd,” or “first” and “second” may be used to simply distinguish a corresponding component from another, and does not limit the components in other aspect (e.g., importance or order).

It is to be understood that if an element (e.g., a first element) is referred to, with or without the term “operatively” or “communicatively”, as “coupled with,” “coupled to,” “connected with,” or “connected to” another element (e.g., a second element), it means that the clement may be coupled with the other element directly (e.g., wiredly), wirelessly, or via a third element.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1240) including one or more instructions that are stored in a storage medium (e.g., internal memory 1236 or external memory 1238) that is readable by a machine (e.g., the electronic device 1201). For example, a processor (e.g., the processor 1220) of the machine (e.g., the electronic device 1201) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Where, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

According to various embodiment, an electronic device may include a housing formed at least in part of a conductive portion, a printed circuit board (PCB) disposed inside the electronic device, a conductive member including a contact area and contacting a conductive portion of the housing through at least a part of the contact area, the contact area including at least one first contact portion which contacts the fastening member, and at least one second contact portion which extends to be curved from the first contact portion and contacts the conductive portion, and a conductive connect member for electrically interconnecting the PCB and the conductive member, the conductive member may be secured to the conductive portion of the housing, and if the conductive member is secured to the conductive portion of the housing, the contact between the second contact portion extending to be curved and the conductive portion may be maintained, and thus the conductive member and the conductive portion of the housing may be electrically connected.

That is, the electronic device may include a housing (one or more of 102, 108, 110 and 111, for example) including a conductive portion 301, a printed circuit board 210 inside the housing, and a conductive antenna member (e.g., the antenna assembly 200 and parts thereof) which is inside the housing and electrically connects the printed circuit board to the housing. The conductive antenna member includes a contact (e.g., 510 and the like) at which the conductive antenna member is secured to and electrically connected to the conductive portion of the housing, where the contact includes a curved portion (like the various first and second portions described above). Here, the contact of the conductive antenna member may further include a second contact portion at a second height from the housing which is smaller than the first height of the first portion, the second contact portion extending curved from the first contact portion and at which the contact contacts and is electrically connected to the conductive portion of the housing and a conductive connect member which electrically connects the contact to the printed circuit board.

According to an embodiment, the electronic device may further include a wireless communication circuit disposed on the PCB, the wireless communication circuit may be electrically connected with the conductive member through the conductive connect member, and by supplying power to a part of the conductive member through the conductive connect member, the wireless communication circuit may transmit and/or receive a signal of a designated frequency band based on an electrical path including the conductive connect member, the conductive member, and the conductive portion of the housing electrically connected with the conductive member.

That is, the electronic device may further include a wireless communication circuit which is on the printed circuit board and electrically connected with the conductive antenna member at the conductive connect member. Here, the conductive antenna member receives power through the conductive connect member, and the wireless communication circuit transmits and/or receives a signal of a frequency band through an electrical path including the conductive connect member (430) through which the the conductive antenna member receives the power, the contact of the conductive antenna member, and the conductive portion of the housing.

According to an embodiment, a least a part of the second contact portion of the contact area formed to be curved may maintain the contact with the conductive portion by elastic force generating in the contact area, and the conductive member and the conductive portion of the housing may be electrically connected. That is, securement of the conductive antenna member to the conductive portion of the housing deforms the second contact portion extending curved from the first contact portion to electrically connect the contact to the conductive portion of the housing.

According to an embodiment, the contact area of the conductive member may include two first contact portions, and two second contact portions, the two first contact portions may have a first height based on one surface of the conductive portion contacting the conductive member, and the two second contact portions may have a second height lower than the first height and bend and extend from the first contact portion.

According to an embodiment, the contact area of the conductive member may include a first hole having a curved rim formed by the first contact portion and the second contact portion, and the two first contact portions may be formed to face each other based on an arbitrary point of the first hole. That is, the contact of the conductive antenna member may further include a first hole which is enclosed by the two first contact portions and the two second contact portions, and with respect to the first hole, the two first contact portions face each other (refer to FIG. 6, for example).

According to an embodiment, the electronic device may further include a fastening member for securing the conductive member and the conductive portion of the housing, an upper surface of the first contact portion may face the fastening member, and a second height of the second contact portion may gradually decrease in size and at least a part of a lower surface of the second contact portion may contact the conductive portion of the housing. That is, the electronic device may further include a fastening member which secures the conductive antenna member and the conductive portion of the housing to each other. Here, a lower surface of the second contact portion faces the conductive portion of the housing and the conductive portion of the housing contacts the conductive antenna member at the lower surface, and the second height of the second contact portion decreases in a direction away from the fastening member (refer to FIG. 7, for example).

According to an embodiment, the conductive member may further include a third contact portion in a flat form, the first contact portion may extend from one end of the third contact portion, and the second contact portion extends from the other end of the third contact portion, and the first contact portion and the second contact portion may be physically disconnected. That is, the contact of the conductive antenna member may further include a third contact portion which is flat and has a first end and a second end opposing each other, the first contact portion which extends from the first end of the third contact portion, and the second contact portion which extends from the second end of the third contact portion and faces the first contact portion with a gap therebetween (refer to FIG. 8).

According to an embodiment, by physically disconnecting the first contact portion and the second contact portion, the contact area may have a curved rim formed by the first contact portion, the second contact portion, and the third contact portion, and include a first hole formed in an open-loop shape which is an open area in part. That is, the contact of the conductive antenna member may further include a first hole which is surrounded by the first contact portion, the second contact portion and the third contact portion and open at the gap.

According to an embodiment, the electronic device may further include a fastening member for securing the conductive member and the conductive portion of the housing, the conductive member may further include a conductive support member attached to the contact area, and if the fastening member secures the conductive member to the conductive portion of the housing, the conductive support member may be disposed between a contact area of the conductive member and the conductive portion.

According to an embodiment, one surface of the conductive support member may be adhered to the second contact portion of the contact area of the conductive member by a conductive adhesive member. That is, the conductive antenna member may further include a conductive support member which is between the contact and the conductive portion of the housing and electrically connects the contact to the conductive portion of the housing, and the conductive support member is adhered to the contact of the conductive antenna member by a conductive adhesive member (refer to FIG. 9, for example).

According to an embodiment, a protrusion for contacting the conductive portion may be formed on the second contact portion of the contact area. That is, the contact of the conductive antenna member may further include a protrusion which protrudes towards the conductive portion of the housing and at which the conductive portion of the housing contacts the contact (refer to FIG. 10, for example).

According to an embodiment, the at least one first contact portion may be formed with a plurality of first contact portions, and the at least one second contact portion may be formed with a plurality of second contact portions. That is, the contact of the conductive antenna member may further include a first contact portion at a first height from the housing, a second contact portion at a second height from the housing which is smaller than the first height, and each of the first contact portion and the second contact portion provided in plural.

According to an embodiment, the conductive member may be a first conductive member, and further include a second conductive member disposed apart from the first conductive member, and by supplying power to the first conductive member through the conductive connect member, the wireless communication circuit disposed on the PCB may transmit and/or receive a signal of a designated frequency band, based on an electrical path including the conductive connect member, the first conductive member connected to a part of the housing, the conductive portion of the housing, and the second conductive member connected to another part of the housing.

That is, the conductive antenna member may further in include the contact provided in plural including a first conductive member (411) which is connected to the housing at a first part of the housing, and a second conductive (412) member which is spaced apart from the first conductive member along the housing and connected to the housing at a second part of the housing different form the first part. The conductive antenna member receives power through the conductive connect member, and the wireless communication circuit transmits and/or receives a signal of a frequency band through an electrical path including the conductive connect member (430) through which the the conductive antenna member receives the power, the first conductive member (411), the conductive portion (301) of the housing, and the second conductive member (412).

According to an embodiment, the conductive member may include a first hole formed in the contact area, the conductive portion of the housing may include a second hole aligned in response to the first hole in a direction toward a front surface of the electronic device, and further include a fastening member for securing the conductive member to the conductive portion of the housing, for the first hole and the second hole which area aligned. That is, the contact may further include a first hole defined therein, the conductive portion of the housing may include a second hole defined therein and aligned with the first hole, and the fastening member extends through the first hole and the second hole to secure the conductive antenna member and the conductive portion of the housing to each other.

According to an embodiment, the conductive connect member may be formed of a flexible radio frequency cable (FRC).

According to various embodiment, an electronic device may include a housing formed at least in part of a conductive portion, a PCB disposed inside the electronic device, an antenna assembly electrically connected with the wireless communication circuit and the conductive portion of the housing, a fastening member for securing a part of the antenna assembly to the conductive portion of the housing, a conductive member including a contact area and contacting a conductive portion of the housing through at least a part of the contact area, the contact area including at least one first contact portion, at least one second contact portion contacting the conductive portion, and a first hole having a curved rim formed by the first contact portion and the second contact portion, and a conductive connect member for electrically interconnecting the PCB and the conductive member, the fastening member may be disposed in the first hole and a second hole formed in the conductive portion, to thus secure the conductive member to the conductive portion of the housing, and if the conductive member is secured to the conductive portion of the housing by the fastening member, the contact between the second contact portion extending to be curved and the conductive portion may be maintained, and thus the conductive member and the conductive portion of the housing may be electrically connected.

According to an embodiment, the electronic device may further include a wireless communication circuit disposed on the PCB, the wireless communication circuit may be electrically connected with the conductive member through the conductive connect member, and by supplying power to a part of the conductive member through the conductive connect member, the wireless communication circuit may transmit and/or receive a signal of a designated frequency band based on an electrical path including the conductive connect member, the conductive member, and the conductive portion of the housing electrically connected with the conductive member.

According to an embodiment, a least a part of the second contact portion of the contact area formed to be curved may maintain the contact with the conductive portion by elastic force generating in the contact area, and thus the conductive member and the conductive portion of the housing may be electrically connected.

According to an embodiment, the contact area of the conductive member may include two first contact portions, and two second contact portions, the two first contact portions may have a first height based on one surface of the conductive portion contacting the conductive member, and the two second contact portions may have a second height lower than the first height and bend and extend from the first contact portion.

According to an embodiment, the at least one first contact portion may be formed with a plurality of first contact portions, and the at least one second contact portion may be formed with a plurality of second contact portions.

According to an embodiment, an electrode device includes a housing including a conductive portion, a printed circuit board inside the housing, and a conductive antenna member which is inside the housing and electrically connects the printed circuit board to the housing. The conductive antenna member includes a contact at which the conductive antenna member is secured to and electrically connected to the conductive portion of the housing. The contact includes a lower surface which faces the conductive portion of the housing, a first portion at which the lower surface is spaced apart from the conductive portion of the housing by a first height, and a second portion at which the lower surface is spaced apart from the conductive portion of the housing by a second height which is smaller than the first height. Here, securement of the conductive antenna member to the conductive portion contacts the lower surface at the second portion and the conductive portion of the housing to each other.

In an embodiment, the first portion curves downward, the second portion extends from an end of the first portion and curves upward, and the securement of the conductive antenna member to the conductive portion deforms the first portion and the second portion (refer to FIGS. 5, 6 and 8-11, for example).

In an embodiment, the first portion is flat, the second portion extends inclined from an end of the first portion, and the securement of the conductive antenna member to the conductive portion deforms the second portion (refer to FIG. 7, for example).

What is claimed is:

1. An electronic device comprising:
a housing including a conductive portion;
a printed circuit board inside the housing; and
a conductive antenna member which is inside the housing and electrically connects the printed circuit board to the housing, the conductive antenna member comprising:
a contact at which the conductive antenna member is secured to and electrically connected to the conductive portion of the housing, and
the contact comprising a curved portion.

2. The electronic device of claim 1, wherein the contact of the conductive antenna member further comprises:
a first contact portion at a first height from the housing,
a second contact portion at a second height from the housing which is smaller than the first height, and
the second contact portion extending curved from the first contact portion and at which the contact contacts and is electrically connected to the conductive portion of the housing.

3. The electronic device of claim 2, wherein the conductive antenna member further comprises a conductive connect member which electrically connects the contact to the printed circuit board.

4. The electronic device of claim 3, further comprising:
a wireless communication circuit which is on the printed circuit board and electrically connected with the conductive antenna member at the conductive connect member,
wherein
the conductive antenna member receives power through the conductive connect member, and
the wireless communication circuit transmits and/or receives a signal of a frequency band through an electrical path comprising the conductive connect member through which the the conductive antenna member receives the power, the contact of the conductive antenna member, and the conductive portion of the housing.

5. The electronic device of claim 2, wherein securement of the conductive antenna member to the conductive portion of the housing deforms the second contact portion extending curved from the first contact portion to electrically connect the contact to the conductive portion of the housing.

6. The electronic device of claim 2, wherein the contact of the conductive antenna member further comprises two first contact portions and two second contact portions.

7. The electronic device of claim 6, wherein the contact of the conductive antenna member further comprises:
a first hole which is enclosed by the two first contact portions and the two second contact portions, and
with respect to the first hole, the two first contact portions face each other.

8. The electronic device of claim 2, further comprising:
a fastening member which secures the conductive antenna member and the conductive portion of the housing to each other,
wherein
a lower surface of the second contact portion faces the conductive portion of the housing and the conductive portion of the housing contacts the conductive antenna member at the lower surface, and
the second height of the second contact portion decreases in a direction away from the fastening member.

9. The electronic device of claim 2, wherein the contact of the conductive antenna member further comprises:
a third contact portion which is flat and has a first end and a second end opposing each other,
the first contact portion which extends from the first end of the third contact portion, and
the second contact portion which extends from the second end of the third contact portion and faces the first contact portion with a gap therebetween.

10. The electronic device of claim 9, wherein the contact of the conductive antenna member further comprises a first hole which is surrounded by the first contact portion, the second contact portion and the third contact portion and open at the gap.

11. The electronic device of claim 1, further comprising:
a fastening member which secures the conductive antenna member and the conductive portion of the housing to each other,
wherein the conductive antenna member further comprises a conductive support member which is between the contact and the conductive portion of the housing and electrically connects the contact to the conductive portion of the housing.

12. The electronic device of claim 11, wherein the conductive support member is adhered to the contact of the conductive antenna member by a conductive adhesive member.

13. The electronic device of claim 1, wherein the contact of the conductive antenna member further comprises a protrusion which protrudes towards the conductive portion of the housing and at which the conductive portion of the housing contacts the contact.

14. The electronic device of claim 1, wherein the contact of the conductive antenna member further comprises:
a first contact portion at a first height from the housing,
a second contact portion at a second height from the housing which is smaller than the first height, and
each of the first contact portion and the second contact portion provided in plural.

15. The electronic device of claim 3, further comprising:
a wireless communication circuit which is on the printed circuit board and electrically connected with the conductive antenna member at the conductive connect member,
wherein
the conductive antenna member further comprises the contact provided in plural including:
a first conductive member which is connected to the housing at a first part of the housing, and
a second conductive member which is spaced apart from the first conductive member along the housing and connected to the housing at a second part of the housing different from the first part,
the conductive antenna member receives power through the conductive connect member, and
the wireless communication circuit transmits and/or receives a signal of a frequency band through an electrical path comprising the conductive connect member through which the the conductive antenna member receives the power, the first conductive member, the conductive portion of the housing, and the second conductive member.

16. The electronic device of claim 1, further comprising:
a fastening member which secures the conductive antenna member and the conductive portion of the housing to each other,
wherein
the contact further comprises a first hole defined therein,
the conductive portion of the housing comprises a second hole defined therein and aligned with the first hole, and
the fastening member extends through the first hole and the second hole to secure the conductive antenna member and the conductive portion of the housing to each other.

17. The electronic device of claim 3, wherein the conductive connect member includes a flexible radio frequency cable.

18. An electronic device comprising:
a housing including a conductive portion;
a printed circuit board inside the housing; and
a conductive antenna member which is inside the housing and electrically connects the printed circuit board to the housing, the conductive antenna member comprising:
a contact at which the conductive antenna member is secured to and electrically connected to the conductive portion of the housing, the contact comprising:
a lower surface which faces the conductive portion of the housing,
a first portion at which the lower surface is spaced apart from the conductive portion of the housing by a first height, and
a second portion at which the lower surface is spaced apart from the conductive portion of the housing by a second height which is smaller than the first height,
wherein securement of the conductive antenna member to the conductive portion contacts the lower surface at the second portion and the conductive portion of the housing to each other.

19. The electronic device of claim 18, wherein
the first portion curves downward,
the second portion extends from an end of the first portion and curves upward, and
the securement of the conductive antenna member to the conductive portion deforms the first portion and the second portion.

20. The electronic device of claim 18, wherein
the first portion is flat,
the second portion extends inclined from an end of the first portion, and
the securement of the conductive antenna member to the conductive portion deforms the second portion.
